(19) United States
(12) Patent Application Publication
(10) Pub. No.: US 2021/0340327 A1
(43) Pub. Date: Nov. 4, 2021

(54) IMIDE OLIGOMER, VARNISH, CURED PRODUCTS THEREOF, AND PREPREG AND FIBER-REINFORCED COMPOSITE MATERIAL USING THESE

(71) Applicant: KANEKA CORPORATION, Osaka (JP)

(72) Inventors: Takefumi Furuta, Osaka (JP); Yoshio Furukawa, Osaka (JP); Rikio Yokota, Osaka (JP); Yuki Kubota, Tokyo (JP); Yuichi Ishida, Tokyo (JP)

(73) Assignee: KANEKA CORPORATION, Osaka (JP)

(21) Appl. No.: 17/375,685

(22) Filed: Jul. 14, 2021

Related U.S. Application Data
(63) Continuation of application No. PCT/JP2019/050543, filed on Dec. 24, 2019.

(30) Foreign Application Priority Data
Jan. 18, 2019 (JP) 2019-007215

(51) Int. Cl. C08G 73/12; C08J 5/24; C09D 179/08

(52) U.S. Cl. CPC C08G 73/128; C08J 2379/08; C09D 179/085; C08J 5/243

(57) ABSTRACT

In order to provide an imide oligomer or the like which can give a cured product exhibiting excellent thermal oxidative stability, an imide oligomer is obtained by reacting together an aromatic tetracarboxylic acid component, an aromatic diamine component, and a terminal capping agent. The imide oligomer contains, in a specified proportion: a compound containing a phenylethynyl group; and a compound containing no carbon-carbon unsaturated bond capable of an addition reaction. One or each of the aromatic tetracarboxylic acid component and the aromatic diamine component contains a component having an asymmetrical and non-planar structure.

### TECHNICAL FIELD

One or more embodiments of the present invention relate to an imide oligomer, a varnish, a cured product of the imide oligomer or the varnish, and a prepreg and a fiber-reinforced composite material each of which uses the imide oligomer, the varnish, or the cured product of the imide oligomer or the varnish.

### BACKGROUND

Polyimides have heat resistance which is of the highest level among polymers and also exhibit excellent mechanical characteristics, excellent electrical characteristics, and the like. For these reasons, polyimides are used as a raw material in a wide range of fields, including aerospace and electrical/electronics fields.

An imide oligomer, in which a terminal(s) of a polyimide is/are capped with a terminal capping agent containing a functional group capable of an addition reaction, exhibits better melt flowability at a low molecular weight as compared with what is generally called “polyimide”. Further, a cured product of the imide oligomer also exhibits high heat resistance. Therefore, such an imide oligomer has been conventionally used as a matrix resin for a molded article or a fiber reinforced composite material.

In particular, an imide oligomer having a terminal capped with 4-(2-phenylethynyl)phthalic anhydride is known to be excellent in balance in terms of the moldability, heat resistance, and mechanical characteristics. For example, Patent Literature 1 discloses a terminally modified imide oligomer and a cured product thereof, the terminally modified imide oligomer being (i) synthesized from raw material compounds including (a) one or more aromatic diamines including 2-phenyl-4,4′-diaminodiphenyl ether and (b) one or more aromatic tetracarboxylic acids, and (ii) terminally modified with 4-(2-phenylethynyl)phthalic anhydride.

Patent Literature 2 discloses a thermosetting solution composition obtained by mixing together: an aromatic tetracarboxylic acid component (A) containing not less than mol % of a 2,3,3′,4′-biphenyltetracarboxylic acid compound; an aromatic diamine component (B) that (i) has no oxygen atom in a molecule thereof and (ii) contains (a) an aromatic diamine which contains, in a molecule thereof, no oxygen atom and in which two carbon-nitrogen bond axes derived from amino groups are present in one straight line and (b) an aromatic diamine which contains, in a molecule thereof, no oxygen atom and in which two carbon-nitrogen bond axes derived from amino groups are not present in one straight line; and a terminal capping agent (C) having a phenylethynyl group.

Further, Patent Literature 3 discloses a crosslinking group-containing polyimide having a molecular terminal capped with (a) 1 mol % to 80 mol % of a crosslinking group-containing dicarboxylic anhydride and (b) 99 mol % to 20 mol % of a dicarboxylic anhydride having no crosslinking group.

### PATENT LITERATURE

[Patent Literature 1]

International Publication No. WO 2010/027020

[Patent Literature 2]

International Publication No. WO 2013/141132

[Patent Literature 3]

Japanese Patent Application Publication, Tokukai, No.

Although cured products disclosed in Patent Literatures 1 and 2 each have excellent thermal and mechanical characteristics, it is considered that there is room for further improvement from the viewpoint of thermal oxidative stability (TOS).

A cured product of the crosslinking group-containing polyimide disclosed in Patent Literature 3 exhibits thermal plasticity, and it is considered that there is room for further improvement from the viewpoint of thermal oxidative stability (TOS).

### SUMMARY

An aspect of one or more embodiments of the present invention has been made in view of the above. An aspect of one or more embodiments of the present invention is to provide an imide oligomer which exhibits excellent thermal oxidative stability (TOS).

In order to solve the above, the inventors of one or more embodiments of the present invention have made diligent studies and as a result, have found that by using, as a terminal capping agent of an imide oligomer, (a) a compound containing a phenylethynyl group that is a functional group capable of an addition reaction and (b) a compound containing no carbon-carbon unsaturated bond capable of an addition reaction in a specific proportion, it is possible to obtain: an imide oligomer that can give a cured product exhibiting excellent thermal oxidative stability (TOS); a varnish obtained by dissolving the imide oligomer in a solvent; and a cured product, a prepreg, and a fiber reinforced composite material each of which is prepared with use of the imide oligomer or the varnish. As a result, the inventors of one or more embodiments of the present invention have accomplished one or more embodiments of the present invention. In other words, one or more embodiments of the present invention include the following aspects.

An imide oligomer obtained by reacting an aromatic tetracarboxylic acid component (A), an aromatic diamine component (B), and a terminal capping agent (C) together,

one or each of the component (A) and the component (B) containing a component having an asymmetrical and non-planar structure,

the agent (C) containing a compound (c1) containing a phenylethynyl group and a compound (c2) containing no carbon-carbon unsaturated bond capable of an addition reaction, the compound (c1) being contained in an amount of more than 50 mol % and less than 100 mol % and the compound (c2) being contained in an amount of more than 0 mol % and less than 50 mol %, with respect to a total amount of the agent (C).

An imide oligomer represented by the following formula (2):

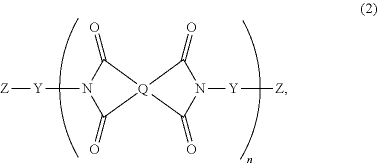

where:

(I) n is an integer;

(II) Q contains at least one structural unit selected from the group consisting of a structural unit represented by the following formula (3) and a structural unit represented by the following formula (4):

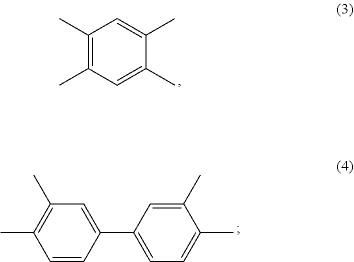

(III) at least a part of Y is a structural unit represented by the following formula (5):

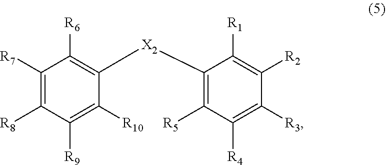

where:

X₂ represents a direct bond or a divalent linking group selected from the group consisting of an ether group, a carbonyl group, a sulfonyl group, a sulfide group, an amide group, an ester group, an isopropylidene group, and an isopropylidene hexafluoride group; and

R₁ to R₁₀ represent the following:
(i) one of R₁ to R₅ represents one selected from the group consisting of an aryl group and a halogenated aryl group, another one of R₁ to R₅ represents a direct bond with a nitrogen atom of an imide group, and the other three of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents a direct bond with a nitrogen atom of an imide group, and the other four of R₆ to R₁₀ each independently represent one selected from the group consisting of a hydrogen atom, a halogen atom, an alkyl group, a halogenated alkyl group, a hydroxy group, a carboxyl group, and an alkoxy group; or
(ii) one of R₁ to R₅ represents a direct bond with a nitrogen atom of an imide group, and the other four of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents one selected from the group consisting of an aryl group and a halogenated aryl group, another one of R₆ to R₁₀ represents a direct bond with a nitrogen atom of an imide group, and the other three of R₆ to R₁₀ each independently represent one selected from the group consisting of a hydrogen atom, a halogen atom, an alkyl group, a halogenated alkyl group, a hydroxy group, a carboxyl group, and an alkoxy group; and
(IV) not less than 85 mol % and not more than 100 mol % of molecular terminals Z have structures each represented by the following formula (6) or (7):

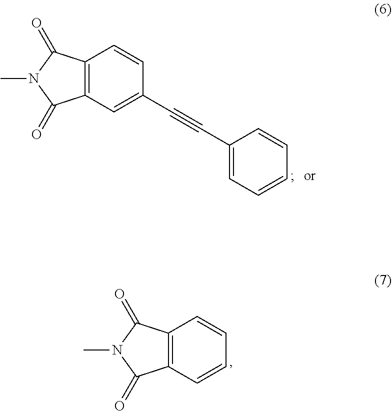 [SMILES: CN1C(=O)c2ccc(C#Cc3ccccc3)cc2C1=O ; CN1C(=O)c2ccccc2C1=O]

in a case where there is a remaining part having a structure excluding the structures each represented by the formula (6) or (7), the molecular terminals Z including one or both of a carboxylic acid terminal derived from the aromatic tetracarboxylic acid component which is a raw material of the imide oligomer and an amine terminal derived from the aromatic diamine component which is a raw material of the imide oligomer, and

more than 50 mol % and less than 100 mol % of the structures each represented by the above formula (6) or (7) being represented by the above formula (6), and more than 0 mol % and less than 50 mol % of the structures each represented by the above formula (6) or (7) being represented by the formula (7).

One or more embodiments of the present invention advantageously make it possible to provide an imide oligomer which exhibits excellent thermal oxidative stability (TOS).

### DETAILED DESCRIPTION OF THE EMBODIMENTS

The following description will discuss one or more embodiments of the present invention in detail. Any numerical range expressed as “A to B” herein means “not less than A and not more than B (i.e., a range from A to B which includes both A and B)” unless otherwise stated.

[1. Imide Oligomer]

The term “imide oligomer” used herein is synonymous with the term “terminally modified imide oligomer” unless otherwise specified.

An imide oligomer in accordance with one or more embodiments of the present invention is obtained by reacting an aromatic tetracarboxylic acid component (A), an aromatic diamine component (B), and a terminal capping agent (C) together. The agent (C) contains: a compound (c1) containing a phenylethynyl group; and a compound (c2) containing no carbon-carbon unsaturated bond capable of an addition reaction. The amount of the compound (c1) is more than 50 mol % and less than 100 mol % and the amount of the compound (c2) is more than 0 mol % and less than 50 mol %, with respect to the total amount of the agent (C). Note that in the present specification, the description “imide oligomer obtained by reacting an aromatic tetracarboxylic acid component (A), an aromatic diamine component (B), and a terminal capping agent (C) together” means an imide oligomer containing a monomer unit derived from the aromatic tetracarboxylic acid component (A), a monomer unit derived from the aromatic diamine component (B), and a monomer unit derived from the terminal capping agent (C).

<Aromatic Tetracarboxylic Acid Component (A)>

The aromatic tetracarboxylic acid component, which is the component (A) for obtaining the imide oligomer in accordance with one or more embodiments of the present invention, encompasses an aromatic tetracarboxylic acid, an aromatic tetracarboxylic dianhydride, and acid derivatives (such as an ester and a salt) of the aromatic tetracarboxylic acid.

The aromatic tetracarboxylic acid component may be a component having a symmetrical and planar structure, a component having a symmetrical and non-planar structure, a component having an asymmetrical and planar structure, or a component having an asymmetrical and non-planar structure. In one or more embodiments of the present invention, from the viewpoint of solubility of the imide oligomer in a solvent, moldability of the imide oligomer, and flexibility of a cured product, it is preferable that the aromatic tetracarboxylic acid component (A) and/or the aromatic diamine component (B), which will be described later, contain the component having an asymmetrical and non-planar structure. Among others, it is more preferable that the aromatic diamine component (B), which will be described later, contain a component having an asymmetrical and non-planar structure.

It is preferable that the aromatic tetracarboxylic acid component (A) contain a 1,2,4,5-benzenetetracarboxylic acid compound and/or a 3,3′,4,4′-biphenyltetracarboxylic acid compound. Further, it is preferable that the aromatic tetracarboxylic acid component (A) contain the 1,2,4,5-benzenetetracarboxylic acid compound. When the aromatic tetracarboxylic acid component (A) does not contain the 1,2,4,5-benzenetetracarboxylic acid compound and/or the 3,3′,4,4′-biphenyltetracarboxylic acid compound, a resultant cured product may have an insufficient glass transition temperature (Tg) and insufficient thermal oxidative stability (TOS).

In the following description, the glass transition temperature may be simply referred to as “Tg”. Note that in the present specification, the glass transition temperature (Tg) and the thermal oxidative stability (TOS) refer to those measured by respective methods described later in Examples. In the present specification, being excellent in thermal oxidative stability is intended to mean that the cured product obtained from the imide oligomer in accordance with one or more embodiments of the present invention is superior in thermal oxidative stability to a cured product obtained from an imide oligomer that has a structure in common with the imide oligomer in accordance with one or more embodiments of the present invention except for the structure of the terminal capping agent.

The 1,2,4,5-benzenetetracarboxylic acid compound encompasses 1,2,4,5-benzenetetracarboxylic acid, 1,2,4,5-benzenetetracarboxylic dianhydride (PMDA), and acid derivatives (such as an ester and a salt) of 1,2,4,5-benzenetetracarboxylic acid.

Similarly, the 3,3′,4,4′-biphenyltetracarboxylic acid compound encompasses 3,3′,4,4′-biphenyltetracarboxylic acid, 3,3′,4,4′-biphenyltetracarboxylic dianhydride (s-BPDA), and acid derivatives (such as an ester and a salt) of 3,3′,4,4′-biphenyltetracarboxylic acid.

In the aromatic tetracarboxylic acid component, particularly, the content of the 1,2,4,5-benzenetetracarboxylic acid compound may be not less than 30 mol %, or not less than 50 mol %. In a case where the content of the 1,2,4,5-benzenetetracarboxylic acid compound is less than 30 mol %, the cured product obtained from the imide oligomer in accordance with one or more embodiments of the present invention may have a lower glass transition temperature (Tg).

Further, in a case where the 1,2,4,5-benzenetetracarboxylic acid compound and the 3,3′,4,4′-biphenyltetracarboxylic acid compound are used in combination as the aromatic tetracarboxylic acid component, the total content of the 1,2,4,5-benzenetetracarboxylic acid compound and the 3,3′,4,4′-biphenyltetracarboxylic acid compound in the aromatic tetracarboxylic acid component may be not less than 50 mol %, not less than 70 mol %, or not less than 90 mol %. In a case where the total content of the 1,2,4,5-benzenetetracarboxylic acid compound and the 3,3′,4,4′-biphenyltetracarboxylic acid compound is set within the above ranges, the cured product obtained from the imide oligomer in accordance with one or more embodiments of the present invention exhibits a high glass transition temperature (Tg) and excellent thermal oxidative stability (TOS).

It is preferable to contain the 1,2,4,5-benzenetetracarboxylic acid compound and/or the 3,3′,4,4′-biphenyltetracarboxylic acid compound, as the aromatic tetracarboxylic acid component which is the component (A) for obtaining the imide oligomer in accordance with one or more embodiments of the present invention. However, provided that the effect of one or more embodiments of the present invention can be yielded, it is possible to contain another aromatic tetracarboxylic acid component excluding the 1,2,4,5-benzenetetracarboxylic acid compound and the 3,3′,4,4′-biphenyltetracarboxylic acid compound. Examples of the another aromatic tetracarboxylic acid component include a 3,3′,4,4′-benzophenonetetracarboxylic acid compound, a 2,3,3′,4′-benzophenonetetracarboxylic acid compound, a 2,3,3′,4′-biphenyltetracarboxylic acid compound, a 2,2′,3,3′-biphenyltetracarboxylic acid compound, a 4,4′-sulfonyl diphthalic acid compound, a 4,4′-thiodiphthalic acid compound, a 4,4′-oxydiphthalic acid compound, a 3,4′-oxydiphthalic acid compound, a 4,4′-isopropylidene diphthalic acid compound, a 4,4′-(hexafluoroisopropylidene)diphthalic acid compound, a 4,4′-[1,4-phenylenebis(oxy)]diphthalic acid compound, a 4,4′-[1,3-phenylenebis(oxy)]diphthalic acid compound, a 1,4,5,8-naphthalenetetracarboxylic acid compound, a 2,3,6,7-naphthalenetetracarboxylic acid compound, a 2,3,6,7-anthracenetetracarboxylic acid compound, a 3,4,9,10-perylenetetracarboxylic acid compound, a 1,2,3,4-benzenetetracarboxylic acid compound, and a 9,9-bis(3,4-dicarboxyphenyl)fluorene compound. These compounds may be used alone or in combination of two or more.

Here, the component having a symmetrical and planar structure encompasses a 1,4,5,8-naphthalenetetracarboxylic acid compound, a 2,3,6,7-naphthalenetetracarboxylic acid compound, a 2,3,6,7-anthracenetetracarboxylic acid compound, a 3,4,9,10-perylenetetracarboxylic acid compound, a 1,2,3,4-benzenetetracarboxylic acid compound, and a 1,2,4,5-benzenetetracarboxylic acid compound. The component having a symmetrical and non-planar structure encompasses a 3,3′,4,4′-benzophenonetetracarboxylic acid compound, a 2,2′,3,3′-biphenyltetracarboxylic acid compound, a 3,3′,4,4′-biphenyltetracarboxylic acid compound, a 4,4′-sulfonyl diphthalic acid compound, a 4,4′-thiodiphthalic acid compound, a 4,4′-oxydiphthalic acid compound, a 4,4′-isopropylidene diphthalic acid compound, a 4,4′-(hexafluoroisopropylidene)diphthalic acid compound, a 4,4′-[1,4-phenylenebis(oxy)]diphthalic acid compound, a 4,4′-[1,3-phenylenebis(oxy)]diphthalic acid compound, and a 9,9-bis(3,4-dicarboxyphenyl)fluorene compound. The component having an asymmetrical and non-planar structure encompasses a 2,3,3′,4′-benzophenonetetracarboxylic acid compound, 2,3,3′,4′-biphenyltetracarboxylic acid compound, and 3,4′-oxydiphthalic acid compound.

<Aromatic Diamine Component (B)>

The aromatic diamine component, which is the component (B) for obtaining the imide oligomer in accordance with one or more embodiments of the present invention, may have a symmetrical and planar structure, a symmetrical and non-planar structure, an asymmetrical and planar structure, or an asymmetrical and non-planar structure. In one or more embodiments of the present invention, from the viewpoint of solubility of the imide oligomer in a solvent, moldability of the imide oligomer, and flexibility of a cured product, it is preferable that the aromatic diamine component (B) contain a component having an asymmetrical and non-planar structure. Among others, from the viewpoint of handleability, it is more preferable that the component having an asymmetrical and non-planar structure be an aromatic diamine component excluding 3,4′-diaminodiphenyl ether (3,4′-ODA). This is because although 3,4′-diaminodiphenyl ether is an aromatic diamine component having an asymmetrical and non-planar structure, 3,4′-diaminodiphenyl ether is a solid having a melting point of not higher than 80° C., and there is a concern in, for example, handleability during storage and transportation of raw materials and handleability for smooth feeding to a reactor.

It is preferable that at least a part of the aromatic diamine component, which is the component (B) for obtaining the imide oligomer in accordance with one or more embodiments of the present invention, be a compound represented by the following formula (1). This is because the compound has an asymmetrical and non-planar structure.

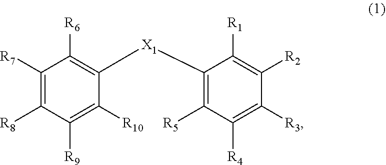

where:

X₁ represents a direct bond or a divalent linking group selected from the group consisting of an ether group, a carbonyl group, a sulfonyl group, a sulfide group, an amide group, an ester group, an isopropylidene group, and an isopropylidene hexafluoride group; and

R₁ to R₁₀ represent the following:
(i) one of R₁ to R₅ represents one selected from the group consisting of an aryl group and a halogenated aryl group, another one of R₁ to R₅ represents an amino group, and the other three of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents an amino group, and the other four of R₆ to R₁₀ each independently represent one selected from the group consisting of a hydrogen atom, a halogen atom, an alkyl group, a halogenated alkyl group, a hydroxy group, a carboxyl group, and an alkoxy group; or
(ii) one of R₁ to R₅ represents an amino group, and the other four of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents one selected from the group consisting of an aryl group and a halogenated aryl group, another one of R₆ to R₁₀ represents an amino group, and the other three of R₆ to R₁₀ each independently represent one selected from the group consisting of a hydrogen atom, a halogen atom, an alkyl group, a halogenated alkyl group, a hydroxy group, a carboxyl group, and an alkoxy group.

In the aromatic diamine component, the content of the compound represented by the formula (1) may be not less than 50 mol %, not less than 70 mol %, or not less than 90 mol %.

In the aromatic diamine component represented by the formula (1), it is preferable to contain 2-phenyl-4,4′-diaminodiphenyl ether as the component having an asymmetrical and non-planar structure. Including 2-phenyl-4,4′-diaminodiphenyl ether, the imide oligomer in accordance with one or more embodiments of the present invention exhibits excellent moldability and excellent solubility in a solvent. In the present specification, the moldability is a concept that encompasses having high-temperature melt flowability and low melt viscosity.

In the aromatic diamine component, particularly, the content of 2-phenyl-4,4′-diaminodiphenyl ether may be not less than 50 mol %, not less than 70 mol %, or not less than mol %. When the content of 2-phenyl-4,4′-diaminodiphenyl ether is low, the imide oligomer in accordance with one or more embodiments of the present invention may be insufficient in moldability and solubility in a solvent.

Further, provided that the effect of one or more embodiments of the present invention can be yielded, it is possible to contain another aromatic diamine that is not 2-phenyl-4,4′-diaminodiphenyl ether, as the aromatic diamine component which is the component (B) for obtaining the imide oligomer in accordance with one or more embodiments of the present invention. Examples of the another aromatic diamine compound include, in addition to the aromatic diamine component represented by the above formula (1), 1,4-diaminobenzene, 1,3-diaminobenzene, 1,2-diaminobenzene, 2,6-diethyl-1,3-diaminobenzene, 4,6-diethyl-2-methyl-1,3-diaminobenzene, 2,5-diaminotoluene, 2,4-diaminotoluene, 2,6-diaminotoluene, 3,3′-diaminodiphenylmethane, 4,4′-diaminodiphenylmethane, bis(2,6-diethyl-4-aminophenyl)methane, 4,4′-methylene-bis(2,6-diethylaniline), bis(2-ethyl-6-methyl-4-aminophenyl)methane, 4,4′-methylene-bis(2-ethyl-6-methylaniline), 2,2′-bis(trifluoromethyl)benzidine, 2,2′-dimethylbenzidine, 3,3′-dimethylbenzidine, 3,3′,5,5′-tetramethylbenzidine, 4,4-diaminooctafluorobiphenyl, 2,2-bis(3-aminophenyl)propane, 2,2-bis(4-aminophenyl)propane, 4,4′-diaminodiphenyl ether (4,4′-ODA), 3,4′-diaminodiphenyl ether (3,4′-ODA), 3,3′-diaminodiphenyl ether (3,3′-ODA), 3,3′-diaminobenzophenone, 4,4′-diaminobenzophenone, 9,9-bis(4-aminophenyl)fluorene, 9,9-bis(4-(4-aminophenoxy)phenyl)fluorene, 1,3-bis(4-aminophenoxy)benzene, 1,3-bis(3-aminophenoxy)benzene, 1,4-bis(4-aminophenoxy)benzene, 1,4-bis(3-aminophenoxy)benzene, 2,2-bis[4-(4-aminophenoxy)phenyl]hexafluoropropane, 2,2-bis[4-(3-aminophenoxy)phenyl]hexafluoropropane, 4,4′-bis(4-aminophenoxy)biphenyl, and 4,4′-bis(3-aminophenoxy)biphenyl. These compounds may be used alone or in combination of two or more.

Among these, examples of the component having a symmetrical and planar structure are 1,4-diaminobenzene, 1,3-diaminobenzene, 1,2-diaminobenzene, 4,6-diethyl-2-methyl-1,3-diaminobenzene, and 2,6-diaminotoluene. Examples of the component having a symmetrical and non-planar structure are 3,3′-diaminodiphenylmethane, 4,4′-diaminodiphenylmethane, bis(2,6-diethyl-4-aminophenyl)methane, 4,4′-methylene-bis(2,6-diethylaniline), bis(2-ethyl-6-methyl-4-aminophenyl)methane, 4,4′-methylene-bis(2-ethyl-6-methylaniline), 2,2′-bis(trifluoromethyl)benzidine, 2,2′-dimethylbenzidine, 4,4′-diaminooctafluorobiphenyl, 2,2-bis(3-aminophenyl)propane, 2,2-bis(4-aminophenyl)propane, 4,4′-diaminodiphenyl ether (4,4′-ODA), 3,3′-diaminodiphenyl ether (3,3′-ODA), 3,3′-diaminobenzophenone, 4,4′-diaminobenzophenone, 9,9-bis(4-aminophenyl)fluorene, 9,9-bis(4-(4-aminophenoxy)phenyl)fluorene, 1,3-bis(4-aminophenoxy)benzene, 1,3-bis(3-aminophenoxy)benzene, 1,4-bis(4-aminophenoxy)benzene, 1,4-bis(3-aminophenoxy)benzene, 2,2-bis[4-(4-aminophenoxy)phenyl]hexafluoropropane, 2,2-bis[4-(3-aminophenoxy)phenyl]hexafluoropropane, 4,4′-bis(4-aminophenoxy)biphenyl, 4,4′-bis(3-aminophenoxy)biphenyl, 3,3′-dimethylbenzidine, and 3,3′,5,5′-tetramethylbenzidine. Examples of the component having an asymmetrical and planar structure are 2,6-diethyl-1,3-diaminobenzene, 2,5-diaminotoluene, and 2,4-diaminotoluene. An example of the component having an asymmetrical and non-planar structure is 3,4′-diaminodiphenyl ether (3,4′-ODA).

<Terminal Capping Agent (C)>

It is preferable that the terminal capping agent, which is the agent (C) for obtaining the imide oligomer in accordance with one or more embodiments of the present invention, contain: a compound (c1) containing a phenylethynyl group; and a compound (c2) containing no carbon-carbon unsaturated bond capable of an addition reaction, and that the compound (c1) be contained in an amount of more than 50 mol % and less than 100 mol % and the compound (c2) be contained in an amount of more than 0 mol % and less than 50 mol %, with respect to a total amount of the agent (C). Further, the terminal capping agent may cap either an amine terminal derived from the aromatic diamine component (B) or a carboxylic acid terminal derived from the aromatic tetracarboxylic acid component (A). The terminal capping agent may be a carboxylic acid compound, and reacts with the amine terminal to form an imide group. In order to obtain the imide oligomer having an amine terminal, it is preferable that the aromatic diamine component be used in a molar quantity stoichiometrically in excess of the molar quantity of the aromatic tetracarboxylic acid component. The aromatic diamine component may be used in a molar quantity within a range of 1.01 times to 2.00 times, or in a molar quantity within a range of 1.02 times to 2.00 times as large as the molar quantity of the aromatic tetracarboxylic acid component.

Further, the molar quantity of the agent (C) may be 1.7 times to 5.0 times, 1.9 times to 4.0 times, or 1.95 times to 2.0 times as large as a molar quantity equivalent to a difference between the molar quantity of the aromatic diamine component and the molar quantity of the aromatic tetracarboxylic acid component. If the molar quantity of the agent (C) is smaller than the above ranges, a large amount of uncapped amine terminals may remain in the imide oligomer, and the thermal oxidative stability (TOS) may not be sufficient. If the molar quantity of the agent (C) is larger than the above ranges, a large amount of an unreacted agent (C) residue may remain in the imide oligomer. Then, the unreacted agent (C) residue may volatilize in a large amount and cause a defect (void) during heat molding of the cured product of the imide oligomer or the fiber reinforced composite material.

As the above compound (c1), it is preferable to use a 4-(2-phenylethynyl)phthalic acid compound. The 4-(2-phenylethynyl)phthalic acid compound encompasses 4-(2-phenylethynyl)phthalic acid, 4-(2-phenylethynyl)phthalic anhydride (PEPA), and acid derivatives (such as an ester and a salt) of 4-(2-phenylethynyl)phthalic acid. As a result of using the 4-(2-phenylethynyl)phthalic acid compound, the cured product obtained from the imide oligomer in accordance with one or more embodiments of the present invention exhibits excellent heat resistance and mechanical characteristics.

In the agent (C), the content of the 4-(2-phenylethynyl)phthalic acid compound used as the compound (c1) may be more than 50 mol % and less than 100 mol %, or more than 55 mol % and not more than 85 mol %. When the content of the 4-(2-phenylethynyl)phthalic acid compound is low, the cured product obtained from the imide oligomer in accordance with one or more embodiments of the present invention may exhibit insufficient toughness. On the other hand, when the content is high, the cured product may have insufficient thermal oxidative stability (TOS).

As the above compound (c2), it is preferable to use a 1,2-benzenedicarboxylic acid compound. The 1,2-benzenedicarboxylic acid compound encompasses 1,2-benzenedicarboxylic acid, 1,2-benzenedicarboxylic anhydride (phthalic anhydride), and acid derivatives (such as an ester and a salt) of 1,2-benzenedicarboxylic acid. As a result of using the 1,2-benzenedicarboxylic acid compound, the cured product obtained from the imide oligomer in accordance with one or more embodiments of the present invention exhibits excellent thermal oxidative stability (TOS).

In the agent (C), the content of the 1,2-benzenedicarboxylic acid compound used as the compound (c2) may be more than 0 mol % and less than 50 mol %, or not less than 15 mol % and not more than 45 mol %. When the content of the 1,2-benzenedicarboxylic acid compound is low, the product obtained from the imide oligomer in accordance with one or more embodiments of the present invention may exhibit insufficient thermal oxidative stability (TOS). On the other hand, when the content is high, the cured product may have insufficient toughness.

It is particularly preferable that the compound (c1) contained in the agent (C) be the 4-(2-phenylethynyl)phthalic acid compound and the compound (c2) contained in the agent (C) be the 1,2-benzenedicarboxylic acid compound.

<Composition and Physical Properties of Imide Oligomer>

The imide oligomer in accordance with one or more embodiments of the present invention may have a polymerization degree n (the number of constitutional repeating units produced by reacting the aromatic tetracarboxylic acid component and the aromatic diamine component together) of not more than 100, or not more than 50. The polymerization degree within the above ranges allows the imide oligomer in accordance with one or more embodiments of the present invention to be excellent in moldability and in solubility in a solvent.

The molecular weight of the imide oligomer in accordance with one or more embodiments of the present invention can be adjusted as appropriate by the ratio of the molar quantity of the aromatic tetracarboxylic acid component and the molar quantity of the aromatic diamine component. The molar quantity of the aromatic diamine component may be stoichiometrically an excessive, equal, or insufficient amount relative to the aromatic tetracarboxylic acid component. It is preferable to use the aromatic diamine component stoichiometrically in an excessive amount. The aromatic diamine component may be used in a molar quantity within a range of 1.01 times to 2.00 times (corresponding to a case where the polymerization degree n of a resultant imide oligomer is 1 to 100 on average), or in a molar quantity within a range of 1.02 times to 2.00 times (corresponding to a case where the polymerization degree n of a resultant imide oligomer is 1 to 50 on average) as large as the molar quantity of the aromatic tetracarboxylic acid component. The polymerization degree within the above ranges allows the imide oligomer in accordance with one or more embodiments of the present invention to be excellent in moldability and in solubility in a solvent. Note that the polymerization degree n of the imide oligomer represents the number of constitutional repeating units produced by reacting the aromatic tetracarboxylic acid component and the aromatic diamine component together.

The imide oligomer in accordance with one or more embodiments of the present invention may be obtained by mixing together imide oligomers having different molecular weights, respectively. The imide oligomer in accordance with one or more embodiments of the present invention may be mixed with another polyimide, a soluble polyimide, or a thermoplastic polyimide. The polyimide, the soluble polyimide, or the thermoplastic polyimide is not particularly limited in type and/or the like, and specifically, may be any commercially available polyimide.

It is preferable that the imide oligomer in accordance with one or more embodiments of the present invention can dissolve in an amount of not less than 30 weight % in a solvent at room temperature. Examples of the solvent include N-methyl-2-pyrrolidone (NMP), N,N-dimethylformamide (DMF), N, N-dimethylacetamide (DMAc), N,N-diethylacetamide, N-methylcaprolactam, γ-butyrolactone (GBL), and cyclohexanone. These solvents may be used alone or in combination of two or more. In selecting any of these solvents, it is possible to apply known techniques regarding soluble polyimides.

The imide oligomer in accordance with one or more embodiments of the present invention can dissolve in an amount of not less than 30 weight % in NMP at room temperature.

The imide oligomer in accordance with one or more embodiments of the present invention has a minimum melt viscosity which may be not more than 10000 Pa·s, not more than 5000 Pa·s, not more than 1000 Pa·s, or not more than 300 Pa·s, in a temperature range of 300° C. to 400° C. The minimum melt viscosity within the above ranges is preferable because such a minimum melt viscosity allows the imide oligomer in accordance with one or more embodiments of the present invention to have excellent moldability. Further, the minimum melt viscosity within the above ranges is preferable also because with such a minimum melt viscosity, when a solvent contained in a prepreg is removed from the prepreg at a high temperature during a molding process of a fiber reinforced composite material, the imide oligomer which remains is allowed to melt and impregnate a space between fibers. Note that the “minimum melt viscosity” herein refers to that measured by a method described later in the Examples.

<Structure of Imide Oligomer>

An imide oligomer in accordance with one or more embodiments of the present invention can be also represented by the following formula (2):

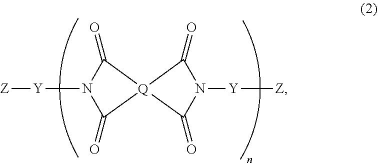

where:

(I) n is an integer;

(II) Q contains at least one structural unit selected from the group consisting of a structural unit represented by the following formula (3) and a structural unit represented by the following formula (4):

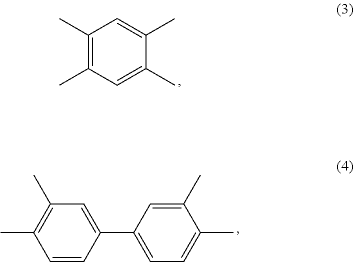

(III) at least a part of Y is a structural unit represented by the following formula (5):

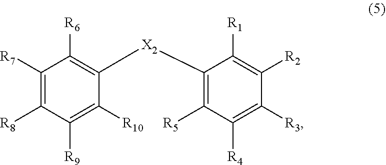

where:

X₂ represents a direct bond or a divalent linking group selected from the group consisting of an ether group, a carbonyl group, a sulfonyl group, a sulfide group, an amide group, an ester group, an isopropylidene group, and an isopropylidene hexafluoride group; and

R₁ to R₁₀ represent the following:
(i) one of R₁ to R₅ represents one selected from the group consisting of an aryl group and a halogenated aryl group, another one of R₁ to R₅ represents a direct bond with a nitrogen atom of an imide group, and the other three of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents a direct bond with a nitrogen atom of an imide group, and the other four of R₆ to R₁₀ each independently represent one selected from the group consisting of a hydrogen atom, a halogen atom, an alkyl group, a halogenated alkyl group, a hydroxy group, a carboxyl group, and an alkoxy group; or
(ii) one of R₁ to R₅ represents a direct bond with a nitrogen atom of an imide group, and the other four of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents one selected from the group consisting of an aryl group and a halogenated aryl group, another one of R₆ to R₁₀ represents a direct bond with a nitrogen atom of an imide group, and the other three of R₆ to R₁₀ each independently represent one selected from the group consisting of a hydrogen atom, a halogen atom, an alkyl group, a halogenated alkyl group, a hydroxy group, a carboxyl group, and an alkoxy group; and

(IV) not less than 85 mol % and not more than 100 mol % of molecular terminals Z have structures each represented by the following formula (6) or (7):

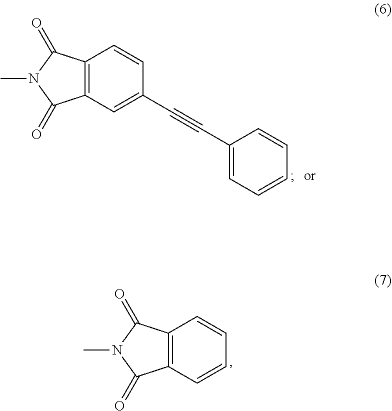 [SMILES: CN1C(=O)c2ccc(C#Cc3ccccc3)cc2C1=O ; CN1C(=O)c2ccccc2C1=O]

in a case where there is a remaining part having a structure excluding the structures each represented by the formula (6) or (7), the molecular terminals Z including one or both of a carboxylic acid terminal derived from the aromatic tetracarboxylic acid component which is a raw material of the imide oligomer and an amine terminal derived from the aromatic diamine component which is a raw material of the imide oligomer, and

more than 50 mol % and less than 100 mol % of the structures each represented by the above formula (6) or (7) being represented by the above formula (6), and more than 0 mol % and less than 50 mol % of the structures each represented by the above formula (6) or (7) being represented by the formula (7).

In the above Q, the imide oligomer may contain, as a main structural unit, at least one structural unit selected from the group consisting of the structural unit represented by the formula (3) and the structural unit represented by the formula (4). Specifically, such a structural unit may be contained in an amount of not less than 50 mol %, not less than 70 mol %, or not less than 90 mol %. In the formula (2), particularly, the Q may be at least one structural unit selected from the group consisting of the structural unit represented by formula (3) and the structural unit represented by the formula (4).

Further, in the above Y, the imide oligomer may contain the structural unit represented by the formula (5) in an amount of not less than 50 mol %, not less than 70 mol %, or not less than 90 mol %. In the formula (2), the Y may be particularly the structural unit represented by the formula (5).

[2. Method of Producing Imide Oligomer]

A method of producing the imide oligomer in accordance with one or more embodiments of the present invention is not particularly limited, and any method may be used. One example will be described below.

The imide oligomer in accordance with one or more embodiments of the present invention can be obtained by mixing together and heating the aromatic tetracarboxylic acid component, the aromatic diamine component, and the terminal capping agent. For example, the aromatic tetracarboxylic dianhydride, the aromatic diamine, and 4-(2-phenylethynyl)phthalic anhydride and 1,2-benzenedicarboxylic anhydride (phthalic anhydride) as the terminal capping agent are used such that the total amount of acid anhydride groups in all of these components is substantially equal to that of amino groups in all of the above components. These components are reacted in a solvent at a temperature of not higher than approximately 100° C., particularly not higher than 80° C., so as to produce an amide acid oligomer (also referred to as an amic acid oligomer) that is an oligomer having an amide-acid bond. Next, the amide acid oligomer is dehydrated and cyclized by a method of adding a chemical imidization agent at a temperature of approximately 0° C. to 140° C., or by a method of heating the amide acid oligomer to a high temperature of 140° C. to 275° C. This gives an imide oligomer.

A particularly preferable method of producing the imide oligomer in accordance with one or more embodiments of the present invention is, for example, a method as described below. First, the aromatic diamine is homogenously dissolved in a solvent. Then, the aromatic tetracarboxylic dianhydride is added to a resultant solution, and reacted at approximately 5° C. to 60° C. and uniformly dissolved. Thereafter, to the solution, 4-(2-phenylethynyl)phthalic anhydride and 1,2-benzenedicarboxylic anhydride (phthalic anhydride) are added as the terminal capping agent, and then reacted at approximately 5° C. to 60° C., so that the amide acid oligomer is produced. Thereafter, a reacted solution is stirred at 140° C. to 275° C. for 5 minutes to 24 hours. This causes the amide acid oligomer to undergo an imidization reaction. In this way, the imide oligomer is produced. It should be noted here that if necessary, the reacted solution can be cooled down to a temperature close to room temperature. This makes it possible to obtain the imide oligomer in accordance with one or more embodiments of the present invention. It is suitable to carry out the above reactions in such a manner that some or all of reaction steps are carried out in an inert gas (such as nitrogen gas or argon gas) atmosphere or in a vacuum.

Examples of the solvent include N-methyl-2-pyrrolidone (NMP), N,N-dimethylformamide (DMF), N,N-dimethylacetamide (DMAc), N,N-diethylacetamide, N-methylcaprolactam, and γ-butyrolactone (GBL). These solvents may be used alone or in combination of two or more. In selecting any of these solvents, it is possible to apply known techniques regarding soluble polyimides.

It is possible to use a solution of the imide oligomer in accordance with one or more embodiments of the present invention thus obtained, as is or after the solution is condensed or diluted as appropriate. Furthermore, if necessary, the imide oligomer in accordance with one or more embodiments of the present invention can be isolated as a product in powder form by pouring the solution into a poor solvent such as water or alcohol, or a non-solvent. The imide oligomer in accordance with one or more embodiments of the present invention may be used in powder form. Alternatively, if necessary, the imide oligomer in accordance with one or more embodiments of the present invention can be used after the product in powder form is dissolved in a solvent.

[3. Varnish]

A varnish in accordance with one or more embodiments of the present invention is obtained by dissolving the imide oligomer in a solvent. The varnish in accordance with one or more embodiments of the present invention can be obtained by dissolving the imide oligomer in powder form into a solvent as described above. Alternatively, the varnish may be obtained as a solution composition of the imide oligomer in accordance with one or more embodiments of the present invention, by using a solution of the imide oligomer in accordance with one or more embodiments of the present invention prior to forming into powder, as is or after the solution is condensed or diluted as appropriate, as described in [2. Method of producing imide oligomer]. As the solvent, the solvents described in [2. Method of producing imide oligomer] can be used.

In order to prepare a prepreg and a fiber reinforced composite material in accordance with one or more embodiments of the present invention, it is preferable that the varnish be excellent in storage stability. Being excellent in storage stability means that the varnish keeps flowability for a long period of time and can be stably stored. The varnish in accordance with one or more embodiments of the present invention does not lose flowability (does not gelatinize) preferably for not less than 1 hour, more preferably not less than 3 hours, even more preferably not less than 6 hours, particularly preferably not less than 12 hours, and most preferably not less than 24 hours, even in a case where the varnish is stored in an environment at room temperature. If the flowability of the varnish is lost before the varnish is stored for an hour in an environment at room temperature, it is difficult to impregnate fibers with the varnish. Consequently, it becomes difficult to obtain the prepreg and the fiber reinforced composite material in accordance with one or more embodiments of the present invention. When the varnish is stored for a long period of time, the varnish may be stored at not higher than 0° C., or at not higher than −10° C.

In order to prevent loss of flowability (gelatinization) in a case where the varnish in accordance with one or more embodiments of the present invention is stored for a long period of time, it is desirable to use an amide solvent such as N-methyl-2-pyrrolidone, which is a more favorable solvent.

[4. Cured Product]

A cured product in accordance with one or more embodiments of the present invention may be obtained by heat-curing the above imide oligomer or the above varnish. Note that as heating the imide oligomer or the varnish causes a reaction between a residue of the 4-(2-phenylethynyl)phthalic acid compound at a terminal(s) of the imide oligomer and other molecules, and as a result of this reaction, (i) the molecular weight of the imide oligomer becomes high and (ii) the imide oligomer cures. It is thought that, in the reaction, a triple bond in the residue of the 4-(2-phenylethynyl)phthalic acid compound and a double bond and a single bond derived from the triple bond contribute to causing the structure of the imide oligomer to become very complex after the reaction.

The form of the cured product in accordance with one or more embodiments of the present invention is not particularly limited. The cured product in accordance with one or more embodiments of the present invention may be formed/molded in a desired form by use of any method. Examples of the form of the cured product in accordance with one or more embodiments of the present invention include two-dimensional and three-dimension forms obtained by forming/molding, such as a film form, a sheet form, a rectangular parallelepiped form, and a rod form. For example, in a case where the film form is to be given by forming, it is possible to apply the varnish of the imide oligomer to a supporting body and heat-cure the varnish for 5 minutes to 200 minutes at 260° C. to 500° C. so as to obtain a film. In other words, one or more embodiments of the present invention encompasses a film consisting of the cured product in accordance with one or more embodiments of the present invention (that is, a film-like cured product).

Alternatively, it is possible to form a preform by (i) filling a mold with the imide oligomer in powder form, and (ii) compression molding at 10° C. to 330° C. and 0.1 MPa to 100 MPa for approximately 1 second to 100 minutes. Then, the cured product in accordance with one or more embodiments of the present invention can be obtained by re-heating the preform at 280° C. to 500° C. for approximately 10 minutes to 40 hours. Note that values of pressure in the present specification all refer to values of actual pressure applied to samples.

The cured product in accordance with one or more embodiments of the present invention has a glass transition temperature (Tg) which may be not lower than 250° C. or not lower than 290° C. Note that the “glass transition temperature (Tg)” herein refers to that measured by a method described later in the Examples.

The cured product in accordance with one or more embodiments of the present invention has a tensile modulus which may be not less than 2.60 GPa, or not less than 2.90 GPa. Note that the “tensile modulus” herein refers to that measured by a method described later in the Examples.

The cured product in accordance with one or more embodiments of the present invention has a tensile breaking strength which may be not less than 110 MPa, or not less than 120 MPa. Note that the “tensile breaking strength” in the present specification refers to that measured by a method described later in the Examples.

The cured product in accordance with one or more embodiments of the present invention has a tensile elongation at break which may be not less than 5.0%, or not less than 6.5%. Note that the “tensile elongation at break” herein refers to that measured by a method described later in the Examples.

[5. Prepreg]

A prepreg in accordance with one or more embodiments of the present invention is obtained by impregnating fibers with the above-described varnish, and if necessary, vaporizing and removing part of the solvent by, for example, heating. Alternatively, the prepreg can be obtained from a semipreg described later. The prepreg in accordance with one or more embodiments of the present invention can be obtained, for example, in the following manner.

First, an imide oligomer solution composition (varnish) is prepared by dissolving the imide oligomer in powder form into a solvent, or by using the reacted solution as is or in a concentrated or diluted state as appropriate. The prepreg can be obtained by impregnating fibers, which are, for example, provided in a planar form and aligned unidirectionally, a fiber fabric, or the like with the imide oligomer varnish having an appropriately adjusted concentration, and then drying the fibers, the fiber fabric, or the like in a dryer at 20° C. to 180° C. for 1 minutes to 20 hours.

At this time, the content of resin adhering to the fibers, the fiber fabric, or the like may be 10 weight % to 60 weight %, or 20 weight % to 50 weight %. Note that the “content of resin” herein refers to a weight of the imide oligomer (resin) adhering to the fibers, the fiber fabric, or the like with respect to the combined weight of (i) the imide oligomer (resin) and (ii) the fibers, the fiber fabric, or the like.

The amount of the solvent adhering to, for example, the fibers, the fiber fabric, or the like may be 1 weight % to 30 weight %, 5 weight % to 25 weight %, or 5 weight % to 20 weight %, with respect to the total weight of the prepreg. In a case where the amount of the solvent adhering to the fibers, the fiber fabric, or the like falls within the above ranges, the prepreg can be easily handled in stacking prepregs. Further, outflow of resin is prevented during a high-temperature molding process of a fiber reinforced composite material, which makes it possible to produce a fiber reinforced composite material exhibiting excellent mechanical strength.

Examples of the fibers include inorganic fiber such as carbon fiber, glass fiber, metal fiber, ceramic fiber, as well as organic synthetic fiber such as polyamide fiber, polyester-based fiber, polyolefin-based fiber, and novoloid fiber. These types of fiber may be used alone or in combination of two or more.

In particular, in order for a fiber reinforced composite material produced from the prepreg to have excellent mechanical characteristics and high heat resistance, it is preferable to use carbon fiber as the reinforcement fibers. The carbon fiber is not particularly limited, provided that the carbon fiber is a material which (i) has a carbon content in a range of 85 weight % to 100 weight % and (ii) is in the form of continuous fibers whose structure is at least partially a graphite structure. Examples of the fiber include polyacrylonitrile (PAN)-based carbon fiber, rayon-based carbon fiber, lignin-based carbon fiber, and pitch-based carbon fiber. Among others, PAN-based carbon fiber, pitch-based carbon fiber, and the like are preferable, because such carbon fibers are versatile, inexpensive, and have high strength.

The carbon fiber typically undergoes sizing. The carbon fiber may be used as is after sizing. If necessary, it is also possible to use carbon fibers in which a sizing agent is used in a small amount, or alternatively, to remove a sizing agent by an existing method such as an organic solvent treatment or a heat treatment.

The sizing agent may be used in an amount of not more than 0.5 weight %, or not more than 0.2 weight %, with respect to the carbon fiber. For carbon fiber, a sizing agent for an epoxy resin is typically used. Thus, the sizing agent may be decomposed at a temperature of not lower than 280° C. at which to cure the imide oligomer in accordance with one or more embodiments of the present invention. Setting the amount of the sizing agent used within the above ranges makes it possible to obtain a good-quality fiber reinforced composite material. In such a fiber reinforced composite material, a defect (void), which may be caused by volatilization of a decomposition product of the sizing agent, is reduced.

It is also possible to open a carbon fiber bundle in advance by use of, for example, air or a roller, and then cause the resin or a solution of the resin to be impregnated between individual carbon fibers. The opening of the fiber bundle makes a resin impregnation distance shorter. This makes it easier to obtain a fiber reinforced composite material in which a defect such as a void has been further reduced or eliminated.

The form of a fiber material constituting the prepreg in accordance with one or more embodiments of the present invention is exemplified by, but not particularly limited to, structures such as unidirectional (UD) materials, textiles (a plain weave, a twill weave, a satin weave, and the like), knitted goods, braided goods, and nonwoven fabrics. The form of the fiber material can be selected as appropriate in accordance with the purpose of use. These forms may be used alone or in combination.

It is preferable that the prepreg thus obtained be stored or transported in a state in which either one surface or each of both surfaces of the prepreg is covered with a resin sheet such as a polyethylene terephthalate (PET) sheet or a covering sheet such as a paper sheet. The prepreg covered as described above is stored and transported, for example, in the form of a roll or a sheet that is cut from the roll.

[6. Semipreg and Fiber Reinforced Composite Material]

A fiber reinforced composite material in accordance with one or more embodiments of the present invention may be obtained by stacking and then heat-curing the above-described prepregs. Alternatively, the fiber reinforced composite material can be obtained by first causing a powder of the imide oligomer to adhere to fibers and then stacking and heat-curing semipregs and/or prepregs which are prepared through the step of fusing the imide oligomer.

Note that the term “semipreg” herein means a resin-reinforcement fiber composite obtained by partially impregnating reinforcement fibers with a resin (e.g., an imide oligomer) (i.e., the reinforcement fibers being put in a semi-impregnated state) and integrating the resin with the reinforcement fibers. A semipreg in accordance with one or more embodiments of the present invention can be obtained by mixing the powder of the imide oligomer with reinforcement fibers. Further, the prepreg can be obtained from the semipreg. For example, the prepreg can be obtained by further heating and melting the semipreg and thereby impregnating the reinforcement fibers with the resin.

As described above, when the imide oligomer is heat-cured and as a result, has a high molecular weight, the imide oligomer has a very complex structure. The fiber reinforced composite material in accordance with one or more embodiments of the present invention can be obtained, for example, in the following manner.

The fiber reinforced composite material can be obtained by (i) cutting the prepreg to a desired size, (ii) stacking a predetermined number of cut prepregs, and (iii) then heat-curing, with use of an autoclave, a hot press, or the like, the cut prepregs at a temperature of 280° C. to 500° C. and a pressure of 0.1 MPa to 100 MPa for approximately 10 minutes to 40 hours. If necessary, prior to the heat-curing, the predetermined number of cut prepregs stacked may be dried, by heating at 200° C. to 310° C. at normal pressure or under reduced pressure for approximately 5 minutes to 40 hours. Other than using the above-described prepregs, the fiber reinforced composite material can be obtained as a laminated plate by (i) first causing a powder of the imide oligomer to adhere to fibers, (ii) stacking semipregs and/or prepregs which are prepared through the step of fusing the imide oligomer, and (iii) then heat-curing the semipregs and/or prepregs in the above-described manner. The fiber reinforced composite material in accordance with one or more embodiments of the present invention may have a glass transition temperature (Tg) of not lower than 300° C., or not lower than 325° C. Note that the “glass transition temperature (Tg)” herein refers to that measured by a method described later in the Examples.

A fiber reinforced composite material structure may be obtained by inserting, between (a) the fiber reinforced composite material and (b) a material of a different kind or an identical kind, the imide oligomer formed in film form, the powder of the imide oligomer, or the semipreg or the prepreg, and then heating and melting, for producing an integrated structure, the imide oligomer, the powder of the imide oligomer, or the semipreg or the prepreg. The material of a different kind here is not particularly limited and can be any material ordinarily used in the present field. Examples of the material of a different kind include, for example, a metal material having a honeycomb-like shape or the like and a core material having a sponge-like shape or the like.

[7. Uses]

The imide oligomer, the cured product of the imide oligomer, and the fiber reinforced composite material of the imide oligomer, and the like can be used in a wide range of fields which require easy moldability, high heat resistance, and high thermal oxidative stability and which include the fields of aircrafts, space industry devices, vehicle engine (peripheral) members, and general industrial uses such as a transfer arm, a robot arm, and slidable members (e.g., a roll material, a friction member, and a bearing). Examples of an aircraft member include a fan case, an inner frame, a rotor blade (e.g., a fan blade), a stationary blade (structure guide vane (SGV)), a bypass duct, and various pipes of engines. Preferable examples of a vehicle member include brake members, engine members (e.g., a cylinder, a motor case, and an air box), and energy regeneration system members.

One or more embodiments of the present invention are not limited to the embodiments, but can be altered by a skilled person in the art within the scope of the claims. One or more embodiments of the present invention also encompass, in its technical scope, any embodiment derived by combining technical means disclosed in differing embodiments.

Note that one or more embodiments of the present invention can be configured as follows.

[1] An imide oligomer obtained by reacting an aromatic tetracarboxylic acid component (A), an aromatic diamine component (B), and a terminal capping agent (C) together,

one or each of the component (A) and the component (B) containing a component having an asymmetrical and non-planar structure,

the agent (C) containing a compound (c1) containing a phenylethynyl group and a compound (c2) containing no carbon-carbon unsaturated bond capable of an addition reaction, the compound (c1) being contained in an amount of more than 50 mol % and less than 100 mol % and the compound (c2) being contained in an amount of more than 0 mol % and less than 50 mol %, with respect to a total amount of the agent (C).

[2] The imide oligomer as set forth in [1], wherein at least a part of the component (B) is a compound represented by the following formula (1):

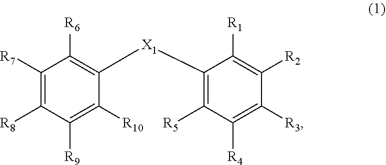

where: X₁ represents a direct bond or a divalent linking group selected from the group consisting of an ether group, a carbonyl group, a sulfonyl group, a sulfide group, an amide group, an ester group, an isopropylidene group, and an isopropylidene hexafluoride group; and

R₁ to R₁₀ represent the following:
(i) one of R₁ to R₅ represents one selected from the group consisting of an aryl group and a halogenated aryl group, another one of R₁ to R₅ represents an amino group, and the other three of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents an amino group, and the other four of R₆ to R₁₀ each independently represent one selected from the group consisting of a hydrogen atom, a halogen atom, an alkyl group, a halogenated alkyl group, a hydroxy group, a carboxyl group, and an alkoxy group; or
(ii) one of R₁ to R₅ represents an amino group, and the other four of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents one selected from the group consisting of an aryl group and a halogenated aryl group, another one of R₆ to R₁₀ represents an amino group, and the other three of R₆ to R₁₀ each independently represent one selected from the group consisting of a hydrogen atom, a halogen atom, an alkyl group, a halogenated alkyl group, a hydroxy group, a carboxyl group, and an alkoxy group.

[3] The imide oligomer as set forth in [1] or [2], wherein the component (A) contains one or both of a 1,2,4,5-benzenetetracarboxylic acid compound and a 3,3′,4,4′-biphenyltetracarboxylic acid compound.

[4] The imide oligomer as set forth in any one of [1] to [3], wherein the component (A) contains a 1,2,4,5-benzenetetracarboxylic acid compound.

[5] The imide oligomer as set forth in any one of [1] to [4], wherein:

the compound (c1) contained in the agent (C) is a 4-(2-phenylethynyl)phthalic acid compound and the compound (c2) contained in the agent (C) is a 1,2-benzenedicarboxylic acid compound; and

a molar quantity of the agent (C) is 1.7 times to 5.0 times as large as a molar quantity equivalent to a difference between a molar quantity of the component (B) and a molar quantity of the component (A).

[6] An imide oligomer represented by the following formula (2):

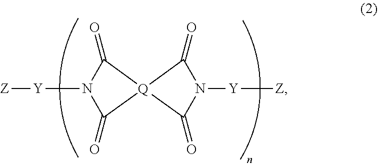

where:

(I) n is an integer;

(II) Q contains at least one structural unit selected from the group consisting of a structural unit represented by the following formula (3) and a structural unit represented by the following formula (4):

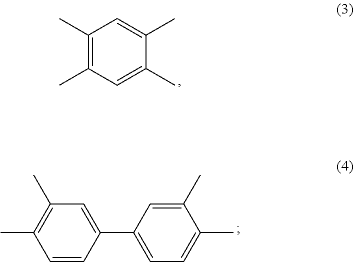

(III) at least a part of Y is a structural unit represented by the following formula (5):

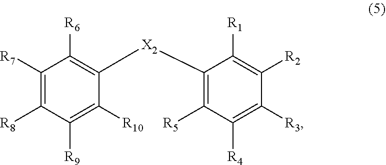

where:

X₂ represents a direct bond or a divalent linking group selected from the group consisting of an ether group, a carbonyl group, a sulfonyl group, a sulfide group, an amide group, an ester group, an isopropylidene group, and an isopropylidene hexafluoride group; and

R₁ to R₁₀ represent the following:
(i) one of R₁ to R₅ represents one selected from the group consisting of an aryl group and a halogenated aryl group, another one of R₁ to R₅ represents a direct bond with a nitrogen atom of an imide group, and the other three of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents a direct bond with a nitrogen atom of an imide group, and the other four of R₆ to R₁₀ each independently represent one selected from the group consisting of a hydrogen atom, a halogen atom, an alkyl group, a halogenated alkyl group, a hydroxy group, a carboxyl group, and an alkoxy group; or
(ii) one of R₁ to R₅ represents a direct bond with a nitrogen atom of an imide group, and the other four of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents one selected from the group consisting of an aryl group and a halogenated aryl group, another one of R₆ to R₁₀ represents a direct bond with a nitrogen atom of an imide group, and the other three of R₆ to R₁₀ each independently represent one selected from the group consisting of a hydrogen atom, a halogen atom, an alkyl group, a halogenated alkyl group, a hydroxy group, a carboxyl group, and an alkoxy group; and

(IV) not less than 85 mol % and not more than 100 mol % of molecular terminals Z have structures each represented by the following formula (6) or (7):

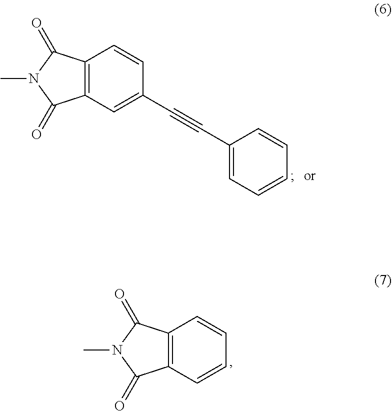 [SMILES: CN1C(=O)c2ccc(C#Cc3ccccc3)cc2C1=O ; CN1C(=O)c2ccccc2C1=O]

in a case where there is a remaining part having a structure excluding the structures each represented by the formula (6) or (7), the molecular terminals Z including one or both of a carboxylic acid terminal derived from the aromatic tetracarboxylic acid component which is a raw material of the imide oligomer and an amine terminal derived from the aromatic diamine component which is a raw material of the imide oligomer, and

more than 50 mol % and less than 100 mol % of the structures each represented by the above formula (6) or (7) being represented by the above formula (6), and more than 0 mol % and less than 50 mol % of the structures each represented by the above formula (6) or (7) being represented by the formula (7).

[7] A varnish obtained by dissolving, in a solvent, an imide oligomer as recited in any one of [1] to [6].

[8] A cured product obtained by heat-curing an imide oligomer as recited in any one of [1] to [6].

[9] A cured product obtained by heat-curing a varnish as recited in [7].

[10] A prepreg obtained by impregnating reinforcement fibers with a varnish as recited in [7].

[11] A fiber reinforced composite material obtained by heat-curing a prepreg as recited in [10].

[12] A semipreg obtained by mixing, with reinforcement fibers, a powder of an imide oligomer as recited in any one of [1] to [6].

[13] A prepreg obtained from a semipreg as recited in [12].

[14] A fiber reinforced composite material obtained by heat-curing a semipreg as recited in [12] or a prepreg as recited in [13].

### EXAMPLES

Examples and Comparative Examples will be described below for the purpose of explaining one or more embodiments of the present invention. One or more embodiments of the present invention are not, however, limited by these. Physical properties were evaluated under the following conditions.

[Test Methods]

(1) Thermal Oxidative Stability (TOS)

<Film-Like Cured Product>

The weight after drying in a vacuum state at not lower than 60° C. for not shorter than 20 hours was defined as “reference weight”. A weight loss as a result of thermal exposure with use of a thermostat (PHH-201M, manufactured by ESPEC CORP.) at 300° C. for 1000 hours in an air-circulating atmosphere was expressed in weight % with respect to the reference weight. The film had a size of approximately 100 mm in length, approximately 50 mm in width, and approximately 0.08 mm to 0.1 mm in thickness (Examples 1 to 6, and Comparative Examples 1, 3, and 5) or approximately 0.15 mm in thickness (Example 7 and Comparative Example 9). The average of measured values of the two samples for each of Examples and Comparative Examples was determined as a TOS value.

<Fiber Reinforced Composite Material>

The weight obtained with use of the above-described device after an elapse of 75 hours at 300° C. was defined as a reference weight, and a weight loss as a result of thermal exposure for 1000 hours from the time point at which the reference weight was obtained was expressed in weight % with respect to the reference weight. Test pieces had a size of 82 mm in length and 15 mm in width. In each of Examples and Comparative Examples, the average of measured values of three samples was determined as a TOS value.

(2) Glass Transition Temperature (Tg)

<Film-Like Cured Product>

A DSC curve was measured by using a Q 100 differential scanning calorimeter (DSC, manufactured by TA Instruments) under flow of a nitrogen gas stream (50 mL/min) and at a temperature increase rate of 20° C./min. The glass transition temperature was considered to be the temperature at the point of intersection of tangent lines to the DSC curve at an inflection point of the DSC curve.

<Fiber Reinforced Composite Material>

Measurements were carried out with use of a DMA-Q-800 dynamic viscoelasticity measuring device (DMA, manufactured by TA Instruments), by a single cantilever method, with 0.1% strain, at a frequency of 1 Hz, and at a temperature increase rate of 5° C./min. The glass transition temperature was considered to be a temperature at the point of intersection of two tangent lines to a storage modulus curve respectively before and after a fall in the storage modulus curve.

(3) Minimum Melt Viscosity

The imide oligomer in powder form was measured with use of a rheometer (DISCOVERY HR-2, manufactured by TA Instruments), by using 25 mm parallel plates, at a temperature increase rate of 5° C./min, at an angular frequency of 6.283 rad/s (1.0 Hz), and with 0.1% strain. Note that the “minimum melt viscosity” means a minimum value of melt viscosity measured under the above conditions.

(4) Storage Stability of Varnish

The imide oligomer in powder form was dissolved in N-methyl-2-pyrrolidone (NMP), which is a solvent, so that the concentration of the imide oligomer became 30 weight %. Then, visual evaluation was carried out for a duration for which the flowability of a varnish left to stand still for storage at room temperature was maintained.

(5) Tensile Modulus, Tensile Breaking Strength, and Tensile Elongation at Break

The film-like cured product was subjected to a tensile test, with use of a tensile tester (TENSILON/UTM-II-20, manufactured by ORIENTEC CO., LTD.), at room temperature and at a tensile speed of 5 mm/min. The test piece had a shape having a size of 30 mm in length and 3 mm in width.

(6) Ultrasonic Flaw Detection Test

The fiber reinforced composite material was measured in water, with use of an ultrasonic flaw detection device (HIS3, manufactured by Krautkramer Japan Co., Ltd.), by using a 3.5 MHz frequency flaw detection probe.

(7) Observation of Cross Section

A cut small test piece of the fiber reinforced composite material was embedded in an epoxy resin (EpoHold R, 2332-32R/EpoHold H, 2332-8H, manufactured by SANKEI Co., Ltd.), and then the epoxy resin was cured. A surface of the epoxy resin was polished with use of a polishing machine (Mecatech 334, manufactured by PRESI SAS), so that a microscope observation sample was prepared. This sample was observed by using an industrial upright microscope (Axio Imager.M2m, manufactured by Carl Zeiss Microscopy GmbH).

[Raw Material Compound]

In Examples and Comparative Examples described below, raw material compounds and solvents were indicated by the following expressions:

PDMA: 1,2,4,5-benzenetetracarboxylic dianhydride (melting point (literature value): 286° C.);
s-BPDA: 3,3′,4,4′-biphenyltetracarboxylic dianhydride (melting point (literature value): 303° C.);
ODA: 4,4′-diaminodiphenyl ether (melting point (literature value): 190° C. to 194° C.);
Ph-ODA: 2-phenyl-4,4′-diaminodiphenyl ether (melting point (literature value): 115° C.);
BAFL: 9,9-bis(4-aminophenyl)fluorene (melting point (literature value): 236° C.); PEPA: 4-(2-phenylethynyl)phthalic anhydride (melting point (literature value): 149° C. to 154° C.);
PA: 1,2-benzenedicarboxylic anhydride (phthalic anhydride) (melting point (literature value): 130° C. to 134° C.); and
NMP: N-methyl-2-pyrolidone.

### Example 1

Into a 140 mL mayonnaise bottle provided with a stirring bar, 7.1263 g (0.02579 mol) of Ph-ODA and 0.9984 g (0.00287 mol) of BAFL, which were diamine components, and 23.7916 g of NMP, which was a solvent, were introduced and stirred at room temperature, so that a homogenous solution was obtained. Next, 5.0003 g (0.02292 mol) of PMDA, which was an acid component, and 9.4931 g of NMP were introduced. Then, after the bottle was filled with nitrogen, stirring was carried out at room temperature for 94 hours, so that a homogenous solution was obtained. Further, 2.4185 g (0.00974 mol) of PEPA and 0.2547 g (0.00172 mol) of PA, which were terminal capping agent components, and 1.1790 g of NMP were introduced. Then, after the bottle was filled with nitrogen, stirring was carried out at room temperature for 1.5 hours, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 195° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure, at 230° C. for 30 minutes and also at 200° C. for 12 hours to give a product (imide oligomer). The powder of the imide oligomer was heat-cured at 370° C. for 1 hour by a hot press, so that a film-like cured product was obtained. Table 1 shows characteristics of the imide oligomer in powder form, a varnish thereof, and the film-like cured product of the imide oligomer.

### Example 2

Into a 140 mL mayonnaise bottle provided with a stirring bar, 7.1263 g (0.02579 mol) of Ph-ODA and 0.9988 g (0.00287 mol) of BAFL, which were diamine components, and 23.2927 g of NMP, which was a solvent, were introduced and stirred at room temperature, so that a homogenous solution was obtained. Next, 5.0004 g (0.02292 mol) of PMDA, which was an acid component, and 10.3655 g of NMP were introduced. Then, after the bottle was filled with nitrogen, stirring was carried out at room temperature for 101 hours, so that a homogenous solution was obtained. Further, 2.1339 g (0.00860 mol) of PEPA and 0.42438 g (0.00287 mol) of PA, which were terminal capping agent components, and 0.5230 g of NMP were introduced. Then, after the bottle was filled with nitrogen, stirring was carried out at room temperature for 4 hours, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 196° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 200° C. for 12 hours to give a product (imide oligomer). The powder of the imide oligomer was heat-cured at 370° C. for 1 hour by a hot press, so that a film-like cured product was obtained. Table 1 shows characteristics of the imide oligomer in powder form, a varnish thereof, and the film-like cured product of the imide oligomer.

### Example 3

Into a 140 mL mayonnaise bottle provided with a stirring bar, 7.1264 g (0.02579 mol) of Ph-ODA and 0.9986 g (0.00287 mol) of BAFL, which were diamine components, and 35.5274 g of NMP, which was a solvent, were introduced and stirred at room temperature, so that a homogenous solution was obtained. Next, 5.0000 g (0.02292 mol) of PMDA, which was an acid component, and 16.9973 g of NMP were introduced. Then, after the bottle was filled with nitrogen, stirring was carried out at room temperature for 22.5 hours, so that a homogenous solution was obtained. Further, 1.8495 g (0.00745 mol) of PEPA and 0.5943 g (0.00401 mol) of PA, which were terminal capping agent components, and 6.3828 g of NMP were introduced. Then, after the bottle was filled with nitrogen, stirring was carried out at room temperature for 1.5 hours, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 195° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 150° C. for 12 hours to give a product (imide oligomer). The powder of the imide oligomer was heat-cured at 370° C. for 1 hour by a hot press, so that a film-like cured product was obtained. Table 1 shows characteristics of the imide oligomer in powder form, a varnish thereof, and the film-like cured product of the imide oligomer.

### Example 4

Into a 140 mL mayonnaise bottle provided with a stirring bar, 7.1264 g (0.02579 mol) of Ph-ODA and 0.9986 g (0.00287 mol) of BAFL, which were diamine components, and 36.2155 g of NMP, which was a solvent, were introduced and stirred at room temperature, so that a homogenous solution was obtained. Next, 5.0000 g (0.02292 mol) of PMDA, which was an acid component, and 15.1156 g of NMP were introduced. Then, after the bottle was filled with nitrogen, stirring was carried out at room temperature for 183 hours, so that a homogenous solution was obtained. Further, 1.5648 g (0.00630 mol) of PEPA and 0.7639 g (0.00516 mol) of PA, which were terminal capping agent components, and 7.6417 g of NMP were introduced. Then, after the bottle was filled with nitrogen, stirring was carried out at room temperature for 1 hour, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 192° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 170° C. for 12 hours to give a product (imide oligomer). The powder of the imide oligomer was heat-cured at 370° C. for 1 hour by a hot press, so that a film-like cured product was obtained. Table 1 shows characteristics of the imide oligomer in powder form, a varnish thereof, and the film-like cured product of the imide oligomer.

### Comparative Example 1

Into a three-neck eggplant flask having a stirring bar, 4.2758 g (0.01547 mol) of Ph-ODA and 0.5992 g (0.00172 mol) of BAFL, which were diamine components, and 13.8187 g of NMP, which was a solvent, were introduced and stirred at room temperature, so that a homogenous solution was obtained. Next, 3.0001 g (0.01375 mol) of PMDA, which was an acid component, and 4.9647 g of NMP were introduced. Then, after the bottle was filled with nitrogen, stirring was carried out at room temperature for 40 hours, so that a homogenous solution was obtained. Further, 1.7071 g (0.00688 mol) of PEPA, which was a terminal capping agent component, and 2.1296 g of NMP were introduced. Then, after the bottle was filled with nitrogen, stirring was carried out at room temperature for 2.5 hours, so that a homogenous solution (amide acid oligomer solution) was obtained. Subsequently, to the three-neck eggplant flask, a nitrogen introduction tube and a thermometer were attached. Then, an imidization reaction was carried out while stirring was carried out at 197° C. for 5 hours under flow of a nitrogen gas stream. After a reacted solution was cooled down to room temperature, the reacted solution was diluted to 10 weight % and then introduced into 775 mL of methanol. Powder which precipitated was separated by filtering. Further, the powder was washed with 400 mL of methanol for 45 minutes and separated by filtering. The powder was dried under reduced pressure at 120° C. to 150° C. for 10 hours so as to give a product (imide oligomer). The powder of the imide oligomer was heat-cured at 370° C. for 1 hour by a hot press, so that a film-like cured product was obtained. Table 1 shows characteristics of the imide oligomer in powder form, a varnish thereof, and the film-like cured product of the imide oligomer.

### Comparative Example 2

Into a 140 mL mayonnaise bottle provided with a stirring bar, 4.2758 g (0.01547 mol) of Ph-ODA and 0.5992 g (0.00172 mol) of BAFL, which were diamine components, and 16.0287 g of NMP, which was a solvent, were introduced and stirred at room temperature, so that a homogenous solution was obtained. Next, 2.9999 g (0.01375 mol) of PMDA, which was an acid component, and 13.4252 g of NMP were introduced. Then, after the bottle was filled with nitrogen, stirring was carried out at room temperature for 48 hours, so that a homogenous solution was obtained. Further, 0.8537 g (0.00344 mol) of PEPA and 0.5093 g (0.00344 mol) of PA, which were terminal capping agent components, and 5.0290 g of NMP were introduced. Then, after the bottle was filled with nitrogen, stirring was carried out at room temperature for 1 hour, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 194° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 236° C. for 1 hour to give a product (imide oligomer). The powder of the imide oligomer was heat-cured at 370° C. for 1 hour by a hot press, so that a film-like cured product was obtained. The film-like cured product was very brittle, and broke when cut into a predetermined size. It was therefore not possible to obtain a test piece having the size required for evaluation of the thermal oxidative stability (TOS). Table 1 shows characteristics of the imide oligomer in powder form, a varnish thereof, and the film-like cured product of the imide oligomer.

### Comparative Example 3

Into a 100 mL sample bottle provided with a stirring bar, 6.2174 g (0.02250 mol) of Ph-ODA and 0.8711 g (0.00250 mol) of BAFL, which were diamine components, and 24.7200 g of NMP, which was a solvent, were introduced and stirred at room temperature, so that a homogenous solution was obtained. Next, 4.3624 g (0.02000 mol) of PMDA, which was an acid component, and 3.0900 g of NMP were introduced. Then, after the bottle was filled with nitrogen, stirring was carried out at room temperature for 2 hours, so that a homogenous solution was obtained. Further, 1.8617 g (0.00750 mol) of PEPA, which was a terminal capping agent component, and 3.2960 g of NMP were introduced. Then, after the bottle was filled with nitrogen, stirring was carried out at room temperature for 1 hour, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 180° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 200° C. for 12 hours to give a product (imide oligomer). The powder of the imide oligomer was heat-cured at 370° C. for 1 hour by a hot press, so that a film-like cured product was obtained. Table 1 shows characteristics of the imide oligomer in powder form, a varnish thereof, and the film-like cured product of the imide oligomer.

### Comparative Example 4

Into a 140 mL mayonnaise bottle provided with a stirring bar, 3.0983 g (0.01547 mol) of ODA and 0.5990 g (0.00172 mol) of BAFL, which were diamine components, and 20.2237 g of NMP, which was a solvent, were introduced and stirred at room temperature, so that a homogenous solution was obtained. Next, 3.0000 g (0.01375 mol) of PMDA, which was an acid component, and 6.0194 g of NMP were introduced. Then, after the bottle was filled with nitrogen, stirring was carried out at room temperature for 24.5 hours, so that a homogenous solution was obtained. Further, 1.2805 g (0.00516 mol) of PEPA and 0.2548 g (0.00172 mol) of PA, which were terminal capping agent components, and 4.1972 g of NMP were introduced. Then, after the bottle was filled with nitrogen, stirring was carried out at room temperature for 1.5 hours, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 194° C. for 5 hours under flow of a nitrogen gas stream. During the imidization reaction, precipitation of the imide oligomer was observed. After a reacted solution was cooled down to room temperature, the reacted solution was introduced into 1000 mL of ion exchange water. Then, powder which precipitated was separated by filtering. The powder obtained as a result of the separation by filtering was dried under reduced pressure at 260° C. for 1 hour to give a product (imide oligomer). This powder of the imide oligomer was insoluble in NMP at room temperature. Further, the powder of the imide oligomer did not exhibit melt flowability even at a temperature of not lower than 300° C. As a result, the powder of the imide oligomer did not form a film but stayed in powder form, even after heat molding with use of a hot press.

TABLE 1

| | | Example | Example | Example | Example | Comparative | Comparative | Comparative | Comparative |
|---|---|---|---|---|---|---|---|---|---|
| | | 1 | 2 | 3 | 4 | Example 1 | Example 2 | Example 3 | Example 4 |
| Molar | PMDA | 4.0 | 4.0 | 4.0 | 4.0 | 4.0 | 4.0 | 4.0 | 4.0 |
| ratio of | s-BPDA | — | — | — | — | — | — | — | — |
| each raw | ODA | — | — | — | — | — | — | — | 4.5 |
| material | Ph-ODA | 4.5 | 4.5 | 4.5 | 4.5 | 4.5 | 4.5 | 4.5 | — |
| compound | BAFL | 0.5 | 0.5 | 0.5 | 0.5 | 0.5 | 0.5 | 0.5 | 0.5 |
| | PEPA | 1.7 | 1.5 | 1.3 | 1.1 | 2.0 | 1.0 | 1.5 | 1.5 |
| | PA | 0.3 | 0.5 | 0.7 | 0.9 | — | 1.0 | — | 0.5 |
| Imide | Set | 4 | 4 | 4 | 4 | 4 | 4 | 4 | 4 |
| oligomer | polymerization | | | | | | | | |
| | degree n | | | | | | | | |
| | Solubility in | ≥30 | ≥30 | ≥30 | ≥30 | ≥30 | ≥30 | ≥30 | 0 |
| | NMP at room | | | | | | | | |
| | temperature | | | | | | | | |
| | (weight %) | | | | | | | | |
| | Minimum melt | 277 | 165 | 107 | 59 | 214 | 68 | 241 | — |
| | viscosity (Pa s) | (353° C.) | (356° C.) | (361° C.) | (368° C.) | (352° C.) | (370° C.) | (354° C.) | |
| | (Melt viscosity | | | | | | | | |
| | is minimum at | | | | | | | | |
| | temperature in | | | | | | | | |
| | parentheses) | | | | | | | | |
| Varnish | Storage | stable | stable | stable | stable | stable | stable | stable | — |
| | stability | for one | for one | for one | for one | for one | for one | for one | |
| | | month or | month or | month or | month or | month or | month or | month or | |
| | | longer | longer | longer | longer | longer | longer | longer | |
| Cured | Glass | 342 | 325 | 308 | 293 | 373 | 285 | 342 | — |
| product | transition | | | | | | | | |
| | temperature | | | | | | | | |
| | Tg (° C.) | | | | | | | | |
| | Tensile | 2.94 | 2.92 | 3.10 | 3.02 | 2.98 | 2.87 | 3.08 | — |
| | modulus | | | | | | | | |
| | (GPa) | | | | | | | | |
| | Tensile | 123.7 | 125.9 | 136.4 | 126.1 | 124.7 | 73.4 | 122.5 | — |
| | breaking | | | | | | | | |
| | strength | | | | | | | | |
| | (MPa) | | | | | | | | |
| | Tensile | 8.1 | 8.3 | 9.1 | 6.7 | 10.4 | 2.7 | 7.7 | — |
| | elongation | | | | | | | | |
| | at break (%) | | | | | | | | |
| | Thermal | −12.1 | −9.1 | −5.4 | −3.9 | −15.2 | — | −14.3 | — |
| | oxidative | | | | | | | | |
| | stability | | | | | | | | |
| | TOS (%) | | | | | | | | |

### Example 5

Into a 140 mL mayonnaise bottle provided with a stirring bar, 4.7509 g (0.01719 mol) of Ph-ODA, which was a diamine component, and 21.3952 g of NMP, which was a solvent, were introduced and stirred at room temperature, so that a homogenous solution was obtained. Next, 3.0000 g (0.01375 mol) of PMDA, which was an acid component, and 9.3021 g of NMP were introduced. Then, after the bottle was filled with nitrogen, stirring was carried out at room temperature for 14.5 hours, so that a homogenous solution was obtained. Further, 1.2805 g (0.00516 mol) of PEPA and 0.2546 g (0.00172 mol) of PA, which were terminal capping agent components, and 3.9705 g of NMP were introduced. Then, after the bottle was filled with nitrogen, stirring was carried out at room temperature for 30 minutes, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 192° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 250° C. for 1 hour to give a product (imide oligomer). The powder of the imide oligomer was heat-cured at 370° C. for 1 hour by a hot press, so that a film-like cured product was obtained. Table 2 shows characteristics of the imide oligomer in powder form, a varnish thereof, and the film-like cured product of the imide oligomer.

### Example 6

Into a 140 mL mayonnaise bottle provided with a stirring bar, 4.1176 g (0.01490 mol) of Ph-ODA, which was a diamine component, and 15.9955 g of NMP, which was a solvent, were introduced and stirred at room temperature, so that a homogenous solution was obtained. Next, 1.3001 g (0.00596 mol) of PMDA and 1.7537 g (0.00596 mol) of s-BPDA, which were acid components, and 9.3748 g of NMP were introduced. Then, after the bottle was filled with nitrogen, stirring was carried out at room temperature for 16.5 hours, so that a homogenous solution was obtained. Further, 1.1096 g (0.00447 mol) of PEPA and 0.2208 g (0.00149 mol) of PA, which were terminal capping agent components, and 6.4850 g of NMP were introduced. Then, after the bottle was filled with nitrogen, stirring was carried out for 30 minutes at room temperature, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 191° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 230° C. for 1 hour to give a product (imide oligomer). The powder of the imide oligomer was heat-cured at 370° C. for 1 hour by a hot press, so that a film-like cured product was obtained. Table 2 shows characteristics of the imide oligomer in powder form, a varnish thereof, and the film-like cured product of the imide oligomer.

### Comparative Example 5

Into a 140 mL mayonnaise bottle provided with a stirring bar, 4.7509 g (0.01719 mol) of Ph-ODA, which was a diamine component, and 19.9848 g of NMP, which was a solvent, were introduced and stirred at room temperature, so that a homogenous solution was obtained. Next, 3.0000 g (0.01375 mol) of PMDA, which was an acid component, and 11.2325 g of NMP were introduced. Then, after the bottle was filled with nitrogen, stirring was carried out at room temperature for 47.5 hours, so that a homogenous solution was obtained. Further, 1.7071 g (0.00688 mol) of PEPA, which was a terminal capping agent component, and 4.4020 g of NMP were introduced. Then, after the bottle was filled with nitrogen, stirring was carried out at room temperature for 1 hour, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 196° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 230° C. for 1 hour to give a product (imide oligomer). The powder of the imide oligomer was heat-cured at 370° C. for 1 hour by a hot press, so that a film-like cured product was obtained. Table 2 shows characteristics of the imide oligomer in powder form, a varnish thereof, and the film-like cured product of the imide oligomer.

### Comparative Example 6

Into a 140 mL mayonnaise bottle provided with a stirring bar, 3.4427 g (0.01719 mol) of ODA, which was a diamine component, and 18.4380 g of NMP, which was a solvent, were introduced and stirred at room temperature, so that a homogenous solution was obtained. Next, 3.0000 g (0.01375 mol) of PMDA, which was an acid component, and 7.4093 g of NMP were introduced. Then, after the bottle was filled with nitrogen, stirring was carried out at room temperature for 26 hours, so that a homogenous solution was obtained. Further, 0.8536 g (0.00344 mol) of PEPA and 0.5092 g (0.00344 mol) of PA, which were terminal capping agent components, and 3.9770 g of NMP were introduced. Then, after the bottle was filled with nitrogen, stirring was carried out at room temperature for 1.5 hours, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 196° C. for 5 hours under flow of a nitrogen gas stream. During the imidization reaction, precipitation of the imide oligomer was observed. After a reacted solution was cooled down to room temperature, the reacted solution was introduced into 1000 mL of ion exchange water. Then, powder which precipitated was separated by filtering. The powder obtained as a result of the separation by filtering was dried under reduced pressure at 260° C. for 1 hour to give a product (imide oligomer). This powder of the imide oligomer was insoluble in NMP at room temperature. Further, the powder of the imide oligomer did not exhibit melt flowability even at a temperature of not lower than 300° C. As a result, the powder of the imide oligomer did not form a film but stayed in powder form, even after heat molding with use of a hot press.

### Comparative Example 7

Into a 140 mL mayonnaise bottle provided with a stirring bar, 3.4426 g (0.01719 mol) of ODA, which was a diamine component, and 19.5381 g of NMP, which was a solvent, were introduced and stirred at room temperature, so that a homogenous solution was obtained. Next, 3.0000 g (0.01375 mol) of PMDA, which was an acid component, and 5.7811 g of NMP were introduced. Then, after the bottle was filled with nitrogen, stirring was carried out at room temperature for 42 hours, so that a homogenous solution was obtained. Further, 1.2805 g (0.00516 mol) of PEPA and 0.2547 g (0.00172 mol) of PA, which were terminal capping agent components, and 4.1590 g of NMP were introduced. Then, after the bottle was filled with nitrogen, stirring was carried out at room temperature for 1.5 hours, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 182° C. for 5 hours under flow of a nitrogen gas stream. During the imidization reaction, precipitation of the imide oligomer was observed. After a reacted solution was cooled down to room temperature, the reacted solution was introduced into 1000 mL of ion exchange water. Then, powder which precipitated was separated by filtering. The powder obtained as a result of the separation by filtering was dried under reduced pressure at 260° C. for 1 hour to give a product (imide oligomer). This powder of the imide oligomer was insoluble in NMP at room temperature. Further, the powder of the imide oligomer did not exhibit melt flowability even at a temperature of not lower than 300° C. As a result, the powder of the imide oligomer did not form a film but stayed in powder form, even after heat molding with use of a hot press.

### Comparative Example 8

Into a 140 mL mayonnaise bottle provided with a stirring bar, 3.4425 g (0.01719 mol) of ODA, which was a diamine component, and 19.3429 g of NMP, which was a solvent, were introduced and stirred at room temperature, so that a homogenous solution was obtained. Next, 1.5000 g (0.00688 mol) of PMDA and 2.0232 g (0.00688 mol) of s-BPDA, which were acid components, and 7.5255 g of NMP were introduced. Then, after the bottle was filled with nitrogen, stirring was carried out at room temperature for 48 hours, so that a homogenous solution was obtained. Further, 1.2804 g (0.00516 mol) of PEPA and 0.2545 g (0.00172 mol) of PA, which were terminal capping agent components, and 4.6639 g of NMP were introduced. Then, after the bottle was filled with nitrogen, stirring was carried out at room temperature for 1.5 hours, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 189° C. for 5 hours under flow of a nitrogen gas stream. During the imidization reaction, precipitation of the imide oligomer was observed. After a reacted solution was cooled down to room temperature, the reacted solution was introduced into 1000 mL of ion exchange water. Then, powder which precipitated was separated by filtering. The powder obtained as a result of the separation by filtering was dried under reduced pressure at 250° C. for 1 hour to give a product (imide oligomer). This powder of the imide oligomer was insoluble in NMP at room temperature. Further, the powder of the imide oligomer did not exhibit melt flowability even at a temperature of not lower than 300° C. As a result, the powder of the imide oligomer did not form a film but stayed in powder form, even after heat molding with use of a hot press.

### Example 7

Into a 140 mL mayonnaise bottle provided with a stirring bar, 4.3437 g (0.01572 mol) of Ph-ODA, which was a diamine component, and 15.9401 g of NMP, which was a solvent, were introduced and stirred at room temperature, so that a homogenous solution was obtained. Next, 3.0001 g (0.01375 mol) of PMDA, which was an acid component, and 9.4141 g of NMP were introduced. Then, after the bottle was filled with nitrogen, stirring was carried out at room temperature for 14 hours, so that a homogenous solution was obtained. Further, 0.7315 g (0.00295 mol) of PEPA and 0.1456 g (0.00098 mol) of PA, which were terminal capping agent components, and 5.2537 g of NMP were introduced. Then, after the bottle was filled with nitrogen, stirring was carried out at room temperature for 2 hours, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 190° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 260° C. for 1 hour to give a product (imide oligomer). The powder of the imide oligomer was heat-cured at 370° C. for 1 hour by a hot press, so that a film-like cured product was obtained. Table 2 shows characteristics of the imide oligomer in powder form, a varnish thereof, and the film-like cured product of the imide oligomer.

### Comparative Example 9

Into a 140 mL mayonnaise bottle provided with a stirring bar, 4.3437 g (0.01572 mol) of Ph-ODA, which was a diamine component, and 15.2610 g of NMP, which was a solvent, were introduced and stirred at room temperature, so that a homogenous solution was obtained. Next, 3.0001 g (0.01375 mol) of PMDA, which was an acid component, and 9.1092 g of NMP were introduced. Then, after the bottle was filled with nitrogen, stirring was carried out at room temperature for 17 hours, so that a homogenous solution was obtained. Further, 0.9756 g (0.00393 mol) of PEPA, which was a terminal capping agent component, and 6.6474 g of NMP were introduced. Then, after the bottle was filled with nitrogen, stirring was carried out at room temperature for 30 minutes, so that a homogenous solution (amide acid oligomer solution) was obtained. Subsequently, the solution was transferred into a three-neck eggplant flask provided with a nitrogen introduction tube, a thermometer, and a stirring bar, and an imidization reaction was carried out while stirring was carried out at 197° C. for 5 hours under flow of a nitrogen gas stream. After a reacted solution was cooled down to room temperature, the reacted solution was diluted to 10 weight % and then introduced into 1000 mL of ion exchange water. Then, powder which precipitated was separated by filtering. The powder obtained as a result of the separation by filtering was dried under reduced pressure at 260° C. for 1 hour to give a product (imide oligomer). The powder of the imide oligomer was heat-cured at 370° C. for 1 hour by a hot press, so that a film-like cured product was obtained. Table 2 shows characteristics of the imide oligomer in powder form, a varnish thereof, and the film-like cured product of the imide oligomer.

TABLE 2

| | | Example | Example | Comparative | Comparative | Comparative | Comparative | Example | Comparative |
|---|---|---|---|---|---|---|---|---|---|
| | | 5 | 6 | Example 5 | Example 6 | Example 7 | Example 8 | 7 | Example 9 |
| Molar | PMDA | 4.0 | 2.0 | 4.0 | 4.0 | 4.0 | 2.0 | 7.0 | 7.0 |
| ratio of | s-BPDA | — | 2.0 | — | — | — | 2.0 | — | — |
| each raw | ODA | — | — | — | 5.0 | 5.0 | 5.0 | — | — |
| material | Ph-ODA | 5.0 | 5.0 | 5.0 | — | — | — | 8.0 | 8.0 |
| compound | BAFL | — | — | — | — | — | — | — | — |
| | PEPA | 1.5 | 1.5 | 2.0 | 1.0 | 1.5 | 1.5 | 1.5 | 2.0 |
| | PA | 0.5 | 0.5 | — | 1.0 | 0.5 | 0.5 | 0.5 | — |
| Imide | Set | 4 | 4 | 4 | 4 | 4 | 4 | 7 | 7 |
| oligomer | polymerization | | | | | | | | |
| | degree n | | | | | | | | |
| | Solubility in | ≥30 | ≥30 | ≥30 | 0 | 0 | 0 | ≥30 | ≥30 |
| | NMP at room | | | | | | | | |
| | temperature | | | | | | | | |
| | (weight %) | | | | | | | | |
| | Minimum melt | 98 | 43 | 161 | — | — | — | 4734 | 4671 |
| | viscosity (Pa s) | (355° C.) | (360° C.) | (347° C.) | | | | (370° C.) | (361° C.) |
| | (Melt viscosity | | | | | | | | |
| | is minimum at | | | | | | | | |
| | temperature in | | | | | | | | |
| | parentheses) | | | | | | | | |
| Varnish | Storage | flowability | flowability | flowability | — | — | — | flowability | flowability |
| | stability | lost | lost after | lost | | | | lost | lost |
| | | within | 17 days | within | | | | within | within |
| | | 2 days | | 2 days | | | | 1 day | 1 day |
| Cured | Glass | 304 | 290 | 347 | — | — | — | 316 | 343 |
| product | transition | | | | | | | | |
| | temperature | | | | | | | | |
| | Tg (° C.) | | | | | | | | |
| | Tensile | 3.01 | 3.16 | 3.02 | — | — | — | 3.03 | 2.86 |
| | modulus | | | | | | | | |
| | (GPa) | | | | | | | | |
| | Tensile | 126.7 | 132.9 | 127.1 | — | — | — | 130.3 | 121.4 |
| | breaking | | | | | | | | |
| | strength | | | | | | | | |
| | (MPa) | | | | | | | | |
| | Tensile | 10.9 | 10.2 | 13.5 | — | — | — | 14.6 | 11.0 |
| | elongation | | | | | | | | |
| | at break (%) | | | | | | | | |
| | Thermal | −7.8 | −5.1 | −13.1 | — | — | — | −7.7 | −10.8 |
| | oxidative | | | | | | | | |
| | stability | | | | | | | | |
| | TOS (%) | | | | | | | | |

### Comparative Example 10

With use of a production apparatus for a prepreg, carbon fibers (PYROFIL MR50R12M, manufactured by Mitsubishi Chemical Corporation) were impregnated with an NMP solution (varnish) of an imide oligomer prepared as in Comparative Example 1, and dried, so that a unidirectional prepreg (fiber mass per unit area: 140 g/m²) was prepared. In the prepreg thus obtained, the content of the imide oligomer was 34.5 weight %, and the content of a volatile component was 14.7 weight %. Note that the volatile component was calculated, on the basis of a weight loss as a result of heating at 250° C. for 30 minutes. The prepreg thus obtained was cut, and cut prepregs were stacked on top of each other so as to form a 30 cm×30 cm stack of [90/0]45 (16 ply). Then, the prepregs thus stacked were wrapped with a release polyimide film and placed on a 45 cm×45 cm stainless steel plate. Then, the prepregs were heated to 260° C. at a temperature increase rate of 5° C./min under a vacuum condition on a 50 cm×50 cm hot plate with use of a vacuum hot pressing machine (VH1.5-1967, manufactured by KITAGAWA SEIKI Co., Ltd.). After the prepregs were kept at 260° C. for 2 hours, the prepregs were further heated to 288° C. at a temperature increase rate of 4° C./min and kept at 288° C. for 40 minutes. While the prepregs were kept at 288° C. for 40 minutes, the pressure applied to the prepregs was increased to 1.4 MPa. Thereafter, while the pressure was maintained, the prepregs were heated to 370° C. at a temperature increase rate of 4° C./min and then were kept at 370° C. for 1 hour. Subsequently, the prepregs were cooled, so that a carbon fiber reinforced composite material having an average thickness of 2.17 mm was obtained. A fiber volume content (Vf) estimated from the average thickness of the carbon fiber reinforced composite material after molding was 57.3%. Further, it was found, from a result of an ultrasonic flaw detection test and from a result of a cross section observation test, that the carbon fiber reinforced composite material was a good-quality product having no significant defect (void). Table 3 shows characteristics of the carbon fiber reinforced composite material obtained above.

### Example 8

With use of a production apparatus for a prepreg, carbon fibers (PYROFIL MR50R12M, manufactured by Mitsubishi Chemical Corporation) were impregnated with an NMP solution (varnish) of an imide oligomer prepared as in Example 2 and dried, so that a unidirectional prepreg (fiber mass per unit area: 142 g/m²) was prepared. In the prepreg thus obtained, the content of the imide oligomer was 34.5 weight %, and the content of a volatile component was 15.7 weight %. Note that the volatile component was calculated, on the basis of a weight loss as a result of heating at 250° C. for 30 minutes. The prepreg thus obtained was cut, and cut prepregs were stacked on top of each other so as to form a 20 cm×20 cm stack of [90/0]45 (16 ply). Then, the prepregs thus stacked were wrapped with a release polyimide film and placed on a 45 cm×45 cm stainless steel plate. Then, the prepregs were heated to 260° C. at a temperature increase rate of 5° C./min under a vacuum condition on a 50 cm×50 cm hot plate with use of a vacuum hot pressing machine (VH1.5-1967, manufactured by KITAGAWA SEIKI Co., Ltd.). After the prepregs were kept at 260° C. for 2 hours, the prepregs were further heated to 288° C. at a temperature increase rate of 4° C./min and kept at 288° C. for 40 minutes. While the prepregs were kept at 288° C. for 40 minutes, the pressure applied to the prepregs was increased to 1.4 MPa. Thereafter, while the pressure was maintained, the prepregs were heated to 370° C. at a temperature increase rate of 4° C./min and then were kept at 370° C. for 1 hour. Subsequently, the prepregs were cooled, so that a carbon fiber reinforced composite material having an average thickness of 2.15 mm was obtained. A fiber volume content (Vf) estimated from the average thickness of the carbon fiber reinforced composite material after molding was 58.7%. Further, it was found, from a result of an ultrasonic flaw detection test and from a result of a cross section observation test, that the carbon fiber reinforced composite material was a good-quality product having no significant defect (void). Table 3 shows characteristics of the carbon fiber reinforced composite material obtained above.

TABLE 3

| | | Comparative | |
|---|---|---|---|
| | | Example 10 | Example 8 |
| Molar ratio of | PMDA | 4.0 | 4.0 |
| each raw | s-BPDA | — | — |
| material | Ph-ODA | 4.5 | 4.5 |
| compound | BAFL | 0.5 | 0.5 |
| | PEPA | 2.0 | 1.5 |
| | PA | — | 0.5 |
| Carbon fiber | Fiber volume content | 57.3 | 58.7 |
| reinforced | Vf (%) | | |
| composite | Glass transition | 372 | 326 |
| material | temperature Tg (° C.) | | |
| | Thermal oxidative | −1.5 | −0.9 |
| | stability TOS (%) | | |

[Explanation of Results]

Examples 1 to 4 uses: as the aromatic tetracarboxylic acid component (A), 1,2,4,5-benzenetetracarboxylic dianhydride; as the aromatic diamine component (B), 2-phenyl-4,4′-diaminodiphenyl ether and 9,9-bis(4-aminophenyl)fluorene; and as the terminal capping agent (C), 4-(2-phenylethynyl) phthalic anhydride and 1,2-benzenedicarboxylic anhydride (phthalic anhydride). Such Examples 1 to 4 have improved thermal oxidative stability (TOS) as compared to Comparative Example 1 which uses, as the agent (C), only 4-(2-phenylethynyl)phthalic anhydride. It is clear from this that it is essential in one or more embodiments of the present invention to use, as the agent (C), a compound containing a phenylethynyl group and a compound containing no carbon-carbon unsaturated bond capable of an addition reaction in combination.

As compared to Examples 1 to 4, the cured product was very low in toughness (brittle) in Comparative Example 2 in which equimolecular amounts of 4-(2-phenylethynyl)phthalic anhydride and 1,2-benzenedicarboxylic anhydride (phthalic anhydride) were used as the agent (C). Therefore, in Comparative Example 2, it was not possible to obtain a test piece having the size required for evaluation of the thermal oxidative stability (TOS). It is clear from this that in a case where 4-(2-phenylethynyl)phthalic anhydride and 1,2-benzenedicarboxylic anhydride (phthalic anhydride) are used in combination as the agent (C), there is a suitable range of the ratio between 4-(2-phenylethynyl)phthalic anhydride and 1,2-benzenedicarboxylic anhydride. It is considered that the cured product was very low in toughness (brittle) because the amount of functional groups capable of an addition reaction in the imide oligomer had decreased excessively.

Further, it is considered that in Comparative Example 3, (i) the molar quantity of 4-(2-phenylethynyl)phthalic anhydride, which is the agent (C), is smaller than the stoichiometric amount, and (ii) there are many amine terminals that have been derived from the component (B) which is a raw material and that are remaining in a large amount as molecular terminals of the imide oligomer. Also in Comparative Example 3, the thermal oxidative stability (TOS) was not sufficient. In Comparative Example 3, the molar quantity of the agent (C) was 1.5 times as large as a molar quantity equivalent to a difference between the molar quantity of the component (B) and the molar quantity of the component (A). On the other hand, in each of Examples 1 to 4, a corresponding ratio of molar quantity was 2.0 times. It is clear from this that there is a preferable range for the stoichiometric amount corresponding to the molecular terminals of the imide oligomer. It is inferred that the reason why the thermal oxidative stability (TOS) was not sufficient in Comparative Example 3 is that when the amine terminals derived from the component (B), which is a raw material, remain in a large amount, side reactions such as decomposition easily occur.

Comparative Example 4 has the same raw material composition as Example 2, except that 4,4′-diaminodiphenyl ether was used, as the component (B), in place of 2-phenyl-4,4′-diaminodiphenyl ether. However, the imide oligomer obtained in Comparative Example 4 did not exhibit melt flowability at a high temperature. Further, it was not possible to evaluate a film-like cured product of the imide oligomer, since even after heat molding with use of a hot press, no film-like cured product could be obtained. Here, 2-phenyl-4,4′-diaminodiphenyl ether is a component having an asymmetrical and non-planar structure. On the other hand, 4,4′-diaminodiphenyl ether is a component having a symmetrical and non-planar structure and is not a component having an asymmetrical and non-planar structure. Meanwhile, since 9,9-bis(4-aminophenyl)fluorene is a component having a symmetrical and non-planar structure, the imide oligomer obtained in Comparative Example 4 as a whole is not a component having an asymmetrical and non-planar structure. It is clear from this that it is necessary for the component (A) and/or the component (B) to include a component having an asymmetrical and non-planar structure. Although in Examples of one or more embodiments of the present invention, an asymmetrical and non-planar structure is introduced in the component (B), one or more embodiments of the present invention, in essence, are not limited thereto. It is possible to introduce an asymmetrical and non-planar structure into the component (A) or into both of the components (A) and (B).

Example 5 uses: as the component (A), 1,2,4,5-benzenetetracarboxylic dianhydride; as the component (B), only 2-phenyl-4,4′-diaminodiphenyl ether; and as the agent (C), 4-(2-phenylethynyl)phthalic anhydride and 1,2-benzenedicarboxylic anhydride (phthalic anhydride). This Example 5 has improved thermal oxidative stability (TOS) as compared to Comparative Example 5 which uses, as the terminal capping agent, only 4-(2-phenylethynyl)phthalic anhydride. It is clear from this that it is essential in one or more embodiments of the present invention to use, as the agent (C), a compound containing a phenylethynyl group and a compound containing no carbon-carbon unsaturated bond capable of an addition reaction in combination. In Example 5, the molar quantity of the agent (C) was 2.0 times as large as a molar quantity equivalent to a difference between the molar quantity of the component (B) and the molar quantity of the component (A).

Comparative Examples 6 and 7 each use, as the component (B), 4,4′-diaminodiphenyl ether in place of 2-phenyl-4,4′-diaminodiphenyl ether. In a comparison with Example 5, the imide oligomers obtained in these Comparative Examples 6 and 7 did not exhibit melt flowability at a high temperature. Further, it was not possible to evaluate a film-like cured product of each of Comparative Examples 6 and 7, since even after heat molding with use of a hot press, no film-like cured product could be obtained. It is clear from this that it is necessary for the component (A) and/or the component (B) to include a component having an asymmetrical and non-planar structure.

Comparative Example 8 has the same raw material composition as Example 6, except that 4,4′-diaminodiphenyl ether was used, as the component (B), in place of 2-phenyl-4,4′-diaminodiphenyl ether. However, the imide oligomer obtained in Comparative Example 8 did not exhibit melt flowability at a high temperature. Further, it was not possible to evaluate a film-like cured product of the imide oligomer obtained in Comparative Example 8, since even after heat molding with use of a hot press, no film-like cured product could be obtained. It is clear from this that it is necessary for the component (A) and/or the component (B) to include a component having an asymmetrical and non-planar structure.

Further, Example 7, which has a set polymerization degree n higher than that of the imide oligomer of Example 5, has improved thermal oxidative stability (TOS) as compared to Comparative Example 9 which has the same set polymerization degree n as Example 7 and which uses only 4-(2-phenylethynyl)phthalic anhydride as the agent (C). It is clear from this that even when the set polymerization degree n is high, it is essential in one or more embodiments of the present invention to use, as the agent (C), a compound containing a phenylethynyl group and a compound containing no carbon-carbon unsaturated bond capable of an addition reaction in combination. In Example 7, the molar quantity of the agent (C) was 2.0 times as large as a molar quantity equivalent to a difference between the molar quantity of the component (B) and the molar quantity of the component (A).

The carbon fiber reinforced composite material prepared by using the imide oligomer obtained in Example 2 (Example 8) had improved thermal oxidative stability (TOS) as compared to that prepared by using the imide oligomer obtained in Comparative Example 1 (Comparative Example 10). It is clear from this that, also in the case of the carbon fiber reinforced composite material prepared by using the imide oligomer, it is essential to use, as the agent (C), a compound containing a phenylethynyl group and a compound containing no carbon-carbon unsaturated bond capable of an addition reaction in combination in one or more embodiments of the present invention.

Note that it is clear from storage stability test results and tensile test results, that in a case where an Example and a Comparative Example having different compositions of terminal capping agents, respectively, exhibit test results equivalent to each other, the Example has improved thermal oxidative stability (TOS) while flowability and strength are not impaired.

One or more embodiments of the present invention can be used in a wide range of fields requiring easy moldability, high heat resistance, and high thermal oxidative stability. Such fields include the fields of aircrafts, space industry devices, general industrial uses, and vehicle engine (peripheral) members.

Although the disclosure has been described with respect to only a limited number of embodiments, those skilled in the art, having benefit of this disclosure, will appreciate that various other embodiments may be devised without departing from the scope of the present disclosure. Accordingly, the scope of the disclosure should be limited only by the attached claims.

1. An imide oligomer obtained by reacting an aromatic tetracarboxylic acid component (A), an aromatic diamine component (B), and a terminal capping agent (C) together,
one or each of the component (A) and the component (B) containing a component having an asymmetrical and non-planar structure,
the agent (C) containing a compound (c1) containing a phenylethynyl group and a compound (c2) containing no carbon-carbon unsaturated bond capable of an addition reaction, the compound (c1) being contained in an amount of more than 50 mol % and less than 100 mol % and the compound (c2) being contained in an amount of more than 0 mol % and less than 50 mol %, with respect to a total amount of the agent (C).

2. The imide oligomer as set forth in claim 1, wherein at least a part of the component (B) is a compound represented by the following formula (1): 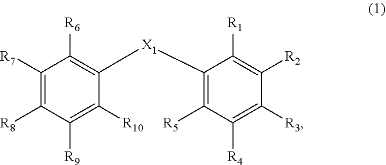
where:
X₁ represents a direct bond or a divalent linking group selected from the group consisting of an ether group, a carbonyl group, a sulfonyl group, a sulfide group, an amide group, an ester group, an isopropylidene group, and an isopropylidene hexafluoride group; and
R₁ to R₁₀ represent the following:
(i) one of R₁ to R₅ represents one selected from the group consisting of an aryl group and a halogenated aryl group, another one of R₁ to R₅ represents an amino group, and the other three of R₁ to R₅ each independently represent one selected from the group consisting of a hydrogen atom, a halogen atom, an alkyl group, a halogenated alkyl group, a hydroxy group, a carboxyl group, and an alkoxy group, and one of R₆ to R₁₀ represents an amino group, and the other four of R₆ to R₁₀ each independently represent one selected from the group consisting of a hydrogen atom, a halogen atom, an alkyl group, a halogenated alkyl group, a hydroxy group, a carboxyl group, and an alkoxy group; or
(ii) one of R₁ to R₅ represents an amino group, and the other four of R₁ to R₅ each independently represent one selected from the group consisting of a hydrogen atom, a halogen atom, an alkyl group, a halogenated alkyl group, a hydroxy group, a carboxyl group, and an alkoxy group, and one of R₆ to R₁₀ represents one selected from the group consisting of an aryl group and a halogenated aryl group, another one of R₆ to R₁₀ represents an amino group, and the other three of R₆ to R₁₀ each independently represent one selected from the group consisting of a hydrogen atom, a halogen atom, an alkyl group, a halogenated alkyl group, a hydroxy group, a carboxyl group, and an alkoxy group.

3. The imide oligomer as set forth in claim 1, wherein the component (A) contains one or both of a 1,2,4,5-benzenetetracarboxylic acid compound and a 3,3′,4,4′-biphenyltetracarboxylic acid compound.

4. The imide oligomer as set forth in claim 1, wherein the component (A) contains a 1,2,4,5-benzenetetracarboxylic acid compound.

5. The imide oligomer as set forth in claim 1, wherein:
the compound (c1) contained in the agent (C) is a 4-(2-phenylethynyl)phthalic acid compound and the compound (c2) contained in the agent (C) is a 1,2-benzenedicarboxylic acid compound; and
a molar quantity of the agent (C) is 1.7 times to 5.0 times as large as a molar quantity equivalent to a difference between a molar quantity of the component (B) and a molar quantity of the component (A).

6. An imide oligomer represented by the following formula (2): 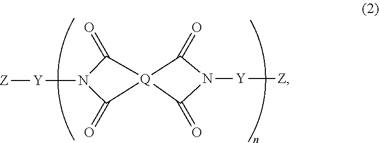
where:
(I) n is an integer;
(II) Q contains at least one structural unit selected from the group consisting of a structural unit represented by the following formula (3) and a structural unit represented by the following formula (4): 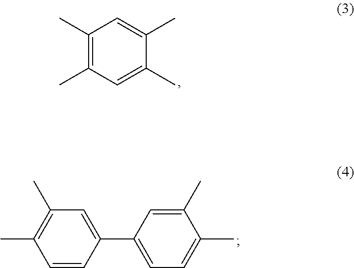
(III) at least a part of Y is a structural unit represented by the following formula (5): 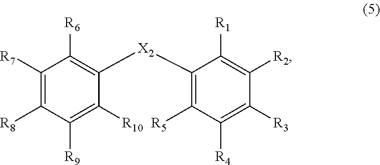
where:
X₂ represents a direct bond or a divalent linking group selected from the group consisting of an ether group, a carbonyl group, a sulfonyl group, a sulfide group, an amide group, an ester group, an isopropylidene group, and an isopropylidene hexafluoride group; and
R₁ to R₁₀ represent the following:
(i) one of R₁ to R₅ represents one selected from the group consisting of an aryl group and a halogenated aryl group, another one of R₁ to R₅ represents a direct bond with a nitrogen atom of an imide group, and the other three of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents a direct bond with a nitrogen atom of an imide group, and the other four of R₆ to R₁₀ each independently represent one selected from the group consisting of a hydrogen atom, a halogen atom, an alkyl group, a halogenated alkyl group, a hydroxy group, a carboxyl group, and an alkoxy group; or
(ii) one of R₁ to R₅ represents a direct bond with a nitrogen atom of an imide group, and the other four of R₁ to R₅ each independently represent one selected from the group consisting of a hydrogen atom, a halogen atom, an alkyl group, a halogenated alkyl group, a hydroxy group, a carboxyl group, and an alkoxy group, and
one of R₆ to R₁₀ represents one selected from the group consisting of an aryl group and a halogenated aryl group, another one of R₆ to R₁₀ represents a direct bond with a nitrogen atom of an imide group, and the other three of R₆ to R₁₀ each independently represent one selected from the group consisting of a hydrogen atom, a halogen atom, an alkyl group, a halogenated alkyl group, a hydroxy group, a carboxyl group, and an alkoxy group; and
(IV) not less than 85 mol % and not more than 100 mol % of molecular terminals Z have structures each represented by the following formula (6) or (7): 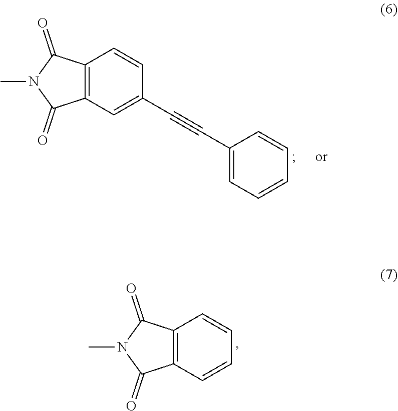 [SMILES: CN1C(=O)c2ccc(C#Cc3ccccc3)cc2C1=O ; CN1C(=O)c2ccccc2C1=O]
in a case where there is a remaining part having a structure excluding the structures each represented by the formula (6) or (7), the molecular terminals Z including one or both of a carboxylic acid terminal derived from an aromatic tetracarboxylic acid component which is a raw material of the imide oligomer and an amine terminal derived from an aromatic diamine component which is a raw material of the imide oligomer, and
more than 50 mol % and less than 100 mol % of the structures each represented by the above formula (6) or (7) being represented by the above formula (6), and more than 0 mol % and less than 50 mol % of the structures each represented by the above formula (6) or (7) being represented by the formula (7).

7. A varnish obtained by dissolving, in a solvent, the imide oligomer as recited in claim 1.

8. A cured product obtained by heat-curing the imide oligomer as recited in claim 1.

9. A cured product obtained by heat-curing the varnish as recited in claim 7.

10. A prepreg obtained by impregnating reinforcement fibers with the varnish as recited in claim 7.

11. A fiber reinforced composite material obtained by heat-curing the prepreg as recited in claim 10.

12. A semipreg obtained by mixing, with reinforcement fibers, a powder of the imide oligomer as recited in claim 1.

13. A prepreg obtained from the semipreg as recited in claim 12.

14. A fiber reinforced composite material obtained by heat-curing the semipreg as recited in claim 12.

15. A fiber reinforced composite material obtained by heat-curing the prepreg as recited in claim 13.
